(19) United States
(12) Patent Application Publication
(10) Pub. No.: US 2004/0119046 A1
(43) Pub. Date: Jun. 24, 2004

(54) Low-volatility functional fluid compositions useful under conditions of high thermal stress and methods for their production and use

(76) Inventors: James Thomas Carey, Medford, NJ (US); Kim Elizabeth Fyfe, Sarnia (CA); Eugenio Sanchez, Turnersville, NJ (US); David J. Baillargeon, Cherry Hill, NJ (US)

Correspondence Address: ExxonMobil Research and Engineering Company, P.O. Box 900, Annandale, NJ, 08801-0900, US

(21) Appl. No.: 10/678,547

(22) Filed: Oct. 3, 2003

Related U.S. Application Data
(60) Provisional application No. 60/432,592, filed on Dec. 11, 2002.

(51) Int. Cl. C09K 5/00

(52) U.S. Cl. 252/71

(57) ABSTRACT

This invention relates to functional fluids incorporating base stocks and base oils that exhibit an unexpected combination of high viscosity index (130 or greater) and a ratio of measured-to-theoretical high-shear/low-temperature viscosity at −30C or lower, and the methods of making them. Specifically, the present invention relates to low-volatility/low-viscosity functional fluids comprising novel base stocks, with particular performance advantages in lubricating materials under high thermal stress, and methods to produce them.

### CROSS-REFERENCE TO RELATED APPLICATION(S)

Non-Provisional Application based on Provisional Application No. 60/432,592 filed Dec. 11, 2002.

This application claims the benefit of U.S. Provisional Application No. 60/432,592 filed Dec. 11, 2002.

### FIELD OF THE INVENTION

The present invention relates to novel low-volatility/low-viscosity functional fluid compositions comprising novel base stocks, with particular performance advantages in lubricating materials under high thermal stress, and methods to produce them. Said base stocks and base oils exhibit an unexpected combination of high viscosity index (130 or greater), a ratio of measured-to-theoretical high-shear/low-temperature viscosity at −30° C. or lower.

### BACKGROUND OF THE INVENTION

This invention relates to novel functional fluid compositions and to methods for optimizing lubrication performance under conditions of high thermal stress. The functional fluid compositions of this invention comprise base stocks and base oils having an unexpectedly advantageous combination of low volatility (as measured by Noack volatility) and good fluidity (as described by a ratio of measured-to-theoretical high-shear/low-temperature viscosity at −30° C. or −35° C. or lower). The low volatility of these functional fluid compositions are found to have surprisingly advantageous performance under high thermal stress, making them especially useful in lubricating mechanical components under high thermal stress, for example sintered metal materials, particularly sintered metal bearings.

Owners and operators of large stationary and mobile equipment require their machines to operate effectively under a variety of operating conditions. Usually, variable-ratio gearboxes, most hydraulic equipment, electric motor actuators, and similar equipment are manipulated using mechanical actuators, for example control rods or selector shafts. A common example of such applications is the gear selector in most automobiles. Remote mechanical actuators are connected to the machines in use with a variety of joints, pivots, and rotators, each of which may contain one or more sintered metal bearings. Sintered metal bearings are lubricated at the time of manufacture where compression of a loose sintered metal sponge submerged in a functional fluid incorporates a proportion of liquid lubricant into the finished metal matrix. The bearings are then broached, bent, and crimped into a final shape suitable for use in various machines. These bearings are internally lubricated by the lubricant used during manufacture, and are frequently used in isolated and complex machines where periodic external lubrication is difficult or impossible. These types of bearings are considered “lubricated for life”, with service life often expected to be 10-30 years. Such extended service lifetimes without external lubrication require the use of robust internal lubricants that are incorporated at the time of manufacture. These robust internal lubricants must demonstrate superior performance values such as long term stability, cleanliness, and in particular low volatility under high thermal stress. Sintered bearing manufacturers expect this type of extended lubricant service life, and consequently expect useful lubricant compositions to demonstrate low volatility losses at elevated temperatures.

A common solution to the problem of the internal lubrication of sintered metal materials is through the use of synthetic lubricant compositions, specifically those based on synthetic polyalpha olefins (PAO) lubricant base oils. For example, many synthetic PAO-based circulating oils have been used for this application. PAO-based lubricant compositions have superior low-volatility properties for service under severe operating conditions compared to that of mineral type oils thereby achieving long service life, and additionally provide excellent high-temperature performance for hot operating conditions. Although PAOs may have certain performance advantages, they also have the significant disadvantage of high cost.

Although traditional Group 1 mineral oils are not suited to meet the performance requirements of internal lubrication of sintered metal materials, one might expect that more modern Group II and Group III type base oils, having high saturates content, high viscosity index, and low sulfur content, could be used to meet the performance requirements of this application. Compared to PAO base oils, Group II and Group III base oil still have significantly higher base oil volatilities. However, selected types of Group II and Group III base oils with low enough base oil volatilities may be expected to be useful as internal lubricants for sintered metal materials and bearings.

Tests used in describing functional fluid compositions of this invention are:

(a) CCS viscosity measured by Cold Cranking Simulator Test (ASTM D5293);

(b) Noack volatility (or evaporative loss) measured by CEC-L-40-A-93;

(c) Viscosity index (VI) measured by ASTM D2270;

(d) Theoretical viscosity calculated by Walther-MacCoull equation (ASTM D341 appendix 1);

(e) Kinematic viscosity measured by ASTM D445

(f) Pour point as measured by ASTM D5950.

(g) Scanning Brookfield Viscosity as measured by ASTM D5133

(h) Brookfield Viscosity as measured by ASTM D2983.

(i) ISO viscosity as defined by the viscosity grade classification in ISO 3448.

The inventors note that the Walther-MacCaull equation of ASTM D341 computes a theoretic kinematic viscosity, while the CCS reports an absolute viscosity. To compute the ratio as used herein, the inventors converted the Walther-MacCaull viscosity as per equation (I).

Theoretical viscosity @ T₁(° C.)=Walther-MacCaull Calculated Kinematic Viscosity @ T₁(° C.)×Density at T₁(° C.) (I)

where T₁ is the desired temperature.

The density at −35° C. is estimated from the density at 20° C. using well-known formula. See, e.g., A. Bondi, “Physical Chemistry of Lubricating Oils”, 1951, p. 5.

A base stock (as opposed to a base oil and a functional fluid composition) is defined as a hydrocarbon stream produced by a single manufacturer to the same specifications (independent of feed source or manufacturers location) and that is identified by a unique formula, product identification number, or both. Base stocks may be manufactured using a variety of different processes including but not limited to distillation, solvent refining, hydrogen processing, oligomerization, esterification, and rerefining. Rerefined stock shall be substantially free from materials introduced through manufacturing, contamination or previous use. A base stock slate is a product line of base stocks that have different viscosities but are in the same base stock grouping and from the same manufacturer. A base oil is the base stock or blend of base stocks used in formulated lubricant or functional fluid compositions. A lubricant composition may be a base stock, a base oil, either alone or mixed with other stocks, oils or functional additives.

### BRIEF DESCRIPTION OF THE DRAWINGS

FIG. 1 graphically compares the measured CCS viscosities against the predicted Walther-MacCoull viscosities at various temperatures.

FIG. 2 graphically illustrates the viscosity versus Noack volatility profiles for various oils.

FIG. 3 graphically compares the kinematic viscosity versus CCS viscosity for various inventive oils and comparative examples.

### SUMMARY OF THE INVENTION

This invention relates to functional fluid compositions comprising novel base stocks and base oils having an unexpectedly advantageous combination of low volatility (as measured by Noack volatility) and good fluidity (as described by a ratio of measured-to-theoretical high-shear/low-temperature viscosity at −30° C. or lower). The low volatility of these functional fluid compositions are found to have surprisingly advantageous performance under conditions of high thermal stress, making them especially useful in internally lubricated sintered metal materials. In addition, these beneficial characteristics of low volatility and good fluidity uniquely differentiate the base oil compositions of this invention from other similar Group III base oils, and further differentiate the functional fluid compositions of this invention from other Group III-based compositions.

This invention relates to functional fluids comprising base stocks and base oils that achieve improved viscosity performance at low temperatures (about −25° C. or lower). The present invention also relates to functional fluid compositions which comprise a base stock or base oil derived from waxy hydrocarbon feedstocks, either from natural or, mineral, or synthetic sources (e.g. Fischer-Tropsch-type processes), and which may be used to meet the simultaneous requirements of low-temperature viscosity and good volatility of internal sintered metal lubricants control. This invention also relates to processes or methods to make such functional fluid compositions.

More specifically, this invention relates to base stocks that have the surprising and unexpected simultaneous combination of properties of:

(a) viscosity index (VI) of 130 or greater,

(b) a pour point of −10° C. or lower,

(c) a ratio of measured-to-theoretical low-temperature viscosity equal to 1.2 or less, at a temperature of −30° C. or lower, where the measured viscosity is cold-crank simulator viscosity and where theoretical viscosity is calculated at the same temperature using the Walther-MacCoull equation.

The base oil compositions recited herein encompass not only individual base stocks as manufactured, but also mixtures or blends of two or more base stocks and/or base oils such that the resulting mixture or blend satisfies the base stock requirements of this invention. The base oil compositions of this invention encompass a range of useful viscosities, with base oil kinematic viscosity at 100° C. of about 1.5 cSt to 8.5 cSt, preferably about 2 cSt to 8 cSt, and more preferably about 3 cSt to 7.5 cSt. The base oils recited herein encompasses a range of useful pour points, with pour points of about −10° C. to greater than −30° C., preferably about −12° C. to greater than −30° C., and more preferably about −14° C. to greater than −30° C. In some instances, the pour point may range from −18° C. to −30° C. and may further range from −20° C. to −30° C.

This invention further relates to base oils that have the surprising and unexpected simultaneous combination of properties of:

(a) a viscosity index (VI) of 130 or greater,

(b) a pour point of −10° C. or lower,

(c) a ratio of measured-to-theoretical low-temperature viscosity equal to 1.2 or less, at a temperature of −30° C. or lower, where the measured viscosity is cold-crank simulator viscosity and where theoretical viscosity is calculated at the same temperature using the Walther-MacCoull equation, and

(d) a percent Noack volatility no greater than that calculated by the formula

−6.882Ln(CCS@−35C)+67.647,

where CCS@−35C is the base oil CCS viscosity in centipoise, tested at −35° C., and where CCS@−35° C. is less than 5500 cP, and Ln(x) is the natural log of x.

Preferably, the novel base stocks and base as used herein will have a measured-to-theoretical low-temperature viscosity of about 0.8 to about 1.2 at a temperature of −30° C. or lower, where the measured viscosity is cold-crank simulator viscosity and where theoretical viscosity is calculated at the same temperature using the Walther-MacCoull equation

One embodiment of this invention encompasses novel functional fluid compositions comprising base oils having low volatility characteristics, with such fluids capable of meeting the performance requirements suited to the internal lubrication of sintered metal materials and bearings. Another embodiment is a functional fluid comprising this base stock or base oil and at least one performance additive. A further embodiment of this invention encompasses functional fluids such as circulating oils and/or compressor oils.

Performance additives as used in this invention may encompass, for example, individual additives as components, combinations of one or more individual additives or components as additive systems, combinations of one or more additives with one or more suitable diluent oils as additive concentrates or packages. Additive concentrate encompasses component concentrates as well as additive packages. Often in making or formulating functional fluids, viscosity modifiers or viscosity index improvers may be used individually as components or concentrates, independent of the use of other performance additives in the form of components, concentrates, or packages.

Surprisingly the low measured-to-theoretical viscosity ratio, which distinguishes one unexpected performance advantage of the base stocks and base oils recited herein, can also be expected to be observed at temperatures below −35° C., for example down to −40° C. or even lower. Thus at these low temperatures, actual viscosity of base stocks and base oils recited herein would be expected to approach the desired, ideal, theoretical viscosity, while comparative base stocks and base oils would be expected to deviate even more strongly away from theoretical viscosity (i.e. to higher measured-to-theoretical viscosity ratios).

Additionally, the base stocks and base oils recited herein may have the following properties:

(a) saturates content of at least 90 wt %, and

(b) a sulfur content of 0.03 wt. % or less

Viscosity index of the base stocks and base oils recited herein may be 130 or greater, or preferably 135 or greater and in some instances, 140 or greater. The desired pour point of the base stocks and base oils is about −10° C. or lower, or preferably −12° C. or lower, or in some instances more preferably −14° C. or lower. In some instances the pour point may be −18 or lower and more preferably, −20° C. and lower. For these base stocks and base oils, the desired measured-to-theoretical ratio of low-temperature cold cranking simulator (CCS) viscosity equals about 1.2 or less, or preferably about 1.16 or less, or more preferably about 1.12 or less. For the low-temperature viscosity profiles of these base stocks and base oils, the desired base stocks and base oils have CCS viscosity @−35° C. of less than 5500 cP, or preferably less than 5200 cP, or in some instances more preferably less than 5000 cP.

The base stocks and base oils recited herein may be used with other base stocks and base oils or co-base stocks and base oils in formulated functional fluids. In some instances, the highly advantageous low-temperature (−30° C. or lower) and low volatility properties of these base stocks and base oils can beneficially improve the performance of functional fluid at concentrations of 20 wt % or greater of the total base stocks and base oils contained in such compositions. Preferably, the base stocks and base oils may be used in combination with other individual base stocks and base oils to gain significant low-temperature performance benefits in finished lubricants or functional fluids. More preferably, the base stocks and base oils may be used at 40 wt % or more of the total base stocks and base oils contained in formulated functional fluid, without detracting from the elements of this invention. And in certain instances, the base oil(s) may be most preferably used at 50 wt % or more of the total base stocks and base oils, or even 70 wt % or more of the total base stocks and base oils in finished functional fluid.

The base stocks and base oils incorporated into this invention may be produced by:

(a) hydrotreating a feedstock having a wax content of at least about 50 wt. %, based on feedstock, with a hydrotreating catalyst under effective hydrotreating conditions such that less than 5 wt. % of the feedstock is converted to 650° F. (343° C.) minus products to produce a hydrotreated feedstock whose VI increase is less than 4 greater than the VI of the feedstock;

(b) stripping or distilling the hydrotreated feedstock to separate gaseous from liquid product; and

(c) hydrodewaxing the liquid product with a dewaxing catalyst which is at least one of ZSM-22, ZSM-23, ZSM-35, ZSM-48, ZSM-57, ferrierite, ECR-42, ITQ-13, MCM-68, MCM-71, beta, fluorided alumina, silica-alumina or fluorided silica alumina under catalytically effective hydrodewaxing conditions wherein the dewaxing catalyst contains at least one Group 9 or Group 10 noble metal, and

(d) optionally, hydrofinishing the product from step (c) with a mesoporous hydrofinishing catalyst from the M41S family under hydrofinishing conditions.

Other embodiments of this invention relate to methods of (a) making formulated functional fluid that comprise base oils that have significant performance benefits in both reduced volatility and reduced low-temperature viscosity, (b) making formulated functional fluid comprising the base oils recited herein with such compositions or fluids having improved viscosity and volatility control under conditions of high thermal stress, and in particular applications, meeting the volatility standards expected of suitable internal lubricants for sintered metal materials and bearings.

### DETAILED DESCRIPTION OF THE INVENTION

Improved internal lubricant performance lifetime in sintered metal materials and bearings are achieved with base oils and lubricant compositions having advantageous low volatility. A novel functional fluid composition based on an unexpected combination of low volatility and good fluidity at low temperature are described, and can be differentiated from other available commercial Group III base stocks based on such characteristic properties.

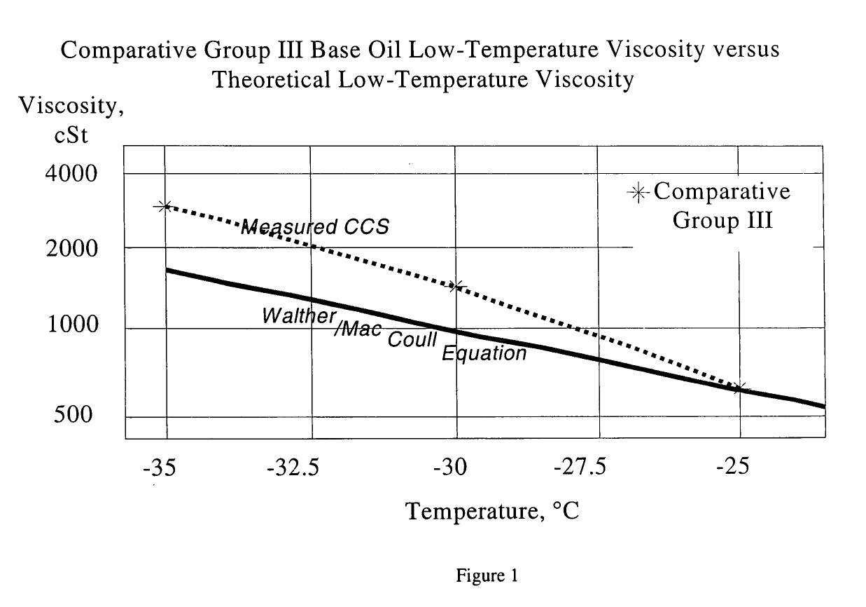

The high viscosity index base stocks recited herein have superior low-temperature performance when compared to other high viscosity index base stocks. The difference in performance is most critical in the temperature range below −30° C., where conventional high viscosity index Group III base stocks deviate significantly from the theoretical viscosity. To illustrate, measured low-temperature CCS viscosity of comparative conventional high viscosity index Group III base stocks tends to deviate to higher viscosity values than that predicted (Walther-MacCoull equation) for the expected theoretical viscosity of the same base stocks at low temperatures (FIG. 1).

The base stocks, and base oils recited herein surprisingly demonstrate the more ideal and highly desirable performance predicted by the theoretical viscosity behavior of base stocks and base oils, as described according to the Walther-MacCoull equation (ASTM D341 appendix). In addition, the base stocks and base oils recited herein are found to be surprisingly different from available commercial Group III base oil regarding the ratio of measured-to-theoretical low-temperature viscosity, where actual viscosity is measured as cold cranking simulator (CCS) viscosity at temperatures of −30° C. or lower, and where theoretical viscosity derives from the Walther-MacCoull equation (ASTM D341, appendix) at the same temperature as the measured CCS viscosity. It has similarly being observed that these base stocks have a much lower scanning-Brookfield viscosity (ASTM D5133) values at low temperature (below −20° C.). CCS viscosity is measured under high sheer conditions, whereas scanning Brookfield viscosity is measured under low sheer conditions.

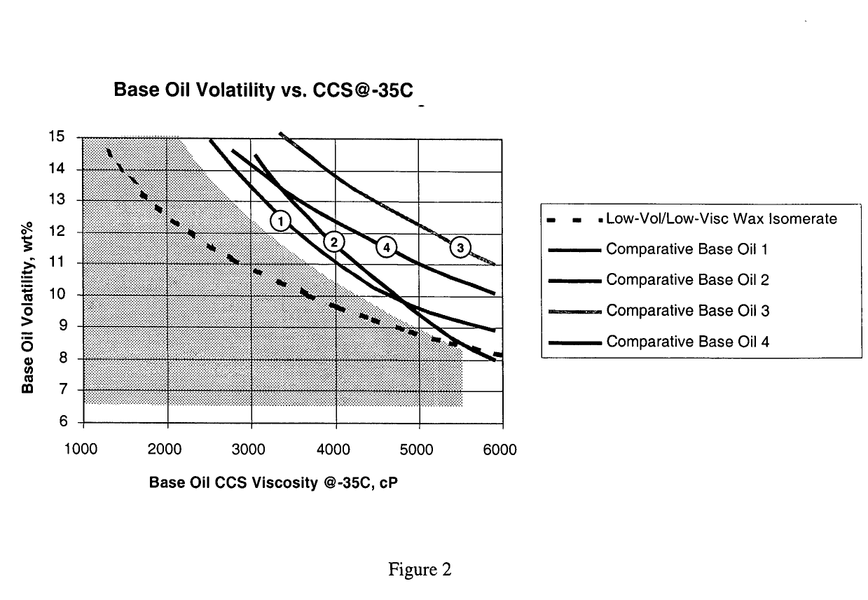

The base stocks and base oils recited herein also demonstrate novel and unexpected performance advantages in having simultaneously lower volatility and lower viscosity than that of these comparative Group III base stocks and base oils (FIG. 2). The low-volatility/low-viscosity base stocks and base oils recited herein demonstrate advantageous Noack volatilities of less than about 20 wt %, preferably less than 16 wt %, and more preferably less than 15 wt %, with low-temperature CCS (cold crank simulator) viscosities measured at −35° C. of less than about 5500 cP, preferably less that about 5200 cP, and in some instances more preferably less than about 5000 cP. In FIG. 2, the shaded area is defined by the equation:

Wt % Noack Volatility≦−6.882Ln(CCS@−35° C.)+67.647

where CCS@−35° C. is the base oil CCS viscosity in centipoise, tested at −35° C., and

where CCS@−35° C. is less than 5500 cP

The base stocks and base oils recited herein have the unique and highly desirable characteristic of a measured-to-theoretical viscosity ratio of 1.2 or lower, preferably 1.16 or lower, and in many instances more preferably 1.12 or lower. Base stocks and base oils having measured-to-theoretical viscosity ratios of less than about 1.2 and with ratios approaching 1.0 are highly desirable, because lower ratios indicate significant advantages in low-temperature performance and operability. The currently available Group III base stocks and base oils, however, have characteristic measured-to-theoretical viscosity ratios of 1.2 and higher, indicating poorer base oil low-temperature viscosity and operability. In some instances, it is preferred to have the measured-to-theoretical viscosity ratio be between about 0.8 and about 1.2.

In addition, the base stocks and base oils incorporated into this invention have the surprising and unexpected simultaneous combination of properties of:

(a) viscosity index (VI) of 130 or greater,

(b) a pour point of −10° C. or lower,

(c) a ratio of measured-to-theoretical low-temperature viscosity equal to 1.2 or less, at a temperature of −30° C. or lower, where the measured viscosity is cold-crank simulator viscosity and where theoretical viscosity is calculated at the same temperature using the Walther-MacCoull equation.

Further, these base stocks and base oils incorporated into this invention have the surprising and unexpected simultaneous combination of properties of:

(a) viscosity index (VI) of 130 or greater,

(b) a pour point of −10° C. or lower,

(c) a ratio of measured-to-theoretical low-temperature viscosity equal to 1.2 or less, at a temperature of −30° C. or lower, where the measured viscosity is cold-crank simulator viscosity and where theoretical viscosity is calculated at the same temperature using the Walther-MacCoull equation, and

(d) a percent Noack volatility no greater than that calculated by the formula

−6.882Ln(CCS@−35° C.)+67.647,

where CCS@−35° C. is the base oil CCS viscosity in centipoise, tested at −35° C., and where CCS@−35° C. is less than 5500 cP.

As used herein, the term functional fluid includes, but is not limited to, lubricant compositions, formulated lubricant compositions, lubes, lubricants, lube products, lube oils, finished lubes, finished lubricants, lubricating oils, greases and the like.

This invention also encompasses lubricants and formulated functional fluids comprising the base oil compositions with the properties:

(a) a viscosity index (VI) of 130 or greater,

(b) a pour point of −10° C. or lower,

(c) a ratio of measured-to-theoretical low-temperature viscosity equal to 1.2 or less, at a temperature of −30° C. or lower, where the measured viscosity is cold-crank simulator viscosity and where theoretical viscosity is calculated at the same temperature using the Walther-MacCoull equation.

This invention also encompasses lubricants and formulated functional fluids comprising the base oil compositions with the properties:

(a) viscosity index (VI) of 130 or greater,

(b) a pour point of −10° C. or lower,

(c) a ratio of measured-to-theoretical low-temperature viscosity equal to 1.2 or less, at a temperature of −30° C. or lower, where the measured viscosity is cold-crank simulator viscosity and where theoretical viscosity is calculated at the same temperature using the Walther-MacCoull equation, and

(d) a percent Noack volatility no greater than that calculated by the formula

−6.882Ln(CCS@−35° C.)+67.647,

where CCS@−35° C. is the base oil CCS viscosity in centipoise, tested at −35° C., and where CCS@−35° C. is less than 5500 cP,

Another aspect of this invention relates to the surprisingly good volatility control of the functional fluid compositions comprising these base stocks. Surprisingly good viscosity control is an additional aspect of this invention. The inventive functional fluid compositions comprising such base stocks, may demonstrate advantageous combination of both volatility control and viscosity control under severe performance conditions, particularly under conditions of high thermal stress. In particular, the inventive functional fluid compositions comprising such base stocks may have advantageous volatility control and viscosity control at the high thermal stress conditions as experienced by internal sintered metal lubricants.

A product performance feature of internal sintered metal lubricants expected by manufacturers of sintered metal materials and bearings is very low lubricant volatility at temperatures approximating those experienced in service. For example, at elevated temperatures and at extended test times, manufacturers would expect lubricant weight loss of less than 1 wt %.

Available Group III base stocks may meet the expected volatility performance of sintered metal internal lubricants, but generally at higher base oil viscosity. The volatility/viscosity profiles of several available commercial Group III base stocks is shown in FIG. 2. These Group III base stocks are limited in simultaneously achieving both low volatility and low viscosity.

Lower base oil viscosity may be expected to provide an advantage in internal lubricating sintered metal materials in that the lower base oil viscosity could allow more effective penetration of the interstitial spaces of the powdered/sintered metal matrix at a given temperature during manufacture and use.

Noack volatility (evaporative loss) of the base stocks and base oils of the is invention may range from less than about 1 wt % to about 20 wt %, depending on the viscosity of the particular base stock or base oil. Generally, the base stocks have advantageous lower volatility properties that are preferred for many lubricant applications. The base stocks recited herein may have Noack volatilities of 20 wt % or less, preferably 18 wt % or less and more preferably, 16 wt % or less. In some applications, the base stocks and base oils may have Noack volatilities less than 15 wt %, specifically even lower than 13 wt %. Additionally, the base stocks and base oils recited herein may also have the following properties:

(a) saturates content of at least 90 wt %, and

(b) a sulfur content of 0.03 wt. % or less.

Products which incorporate the base stocks or base oils recited herein clearly have an advantage over other similar products made from conventional Group II and Group III base stocks. One embodiment of this invention is a formulated functional fluids comprising base stocks and base oils recited herein in combination with one or more additional co-base stocks and base oils. Another embodiment of this invention is a formulated functional fluids comprising base stocks and base oils recited herein in combination with one or more performance additives. The amount and type of additional base stock or additive that may be used with base stocks of this invention are limited such that the functional fluid comprising this total base oil mixture and optionally one or more performance additives meet the low volatility performance suitable for internal lubricants for sintered metal materials and bearings

Performance additives as used in this invention may encompass, for example, individual additives as components, combinations of one or more individual additives or components as additive systems, combinations of one or more additives with one or more suitable diluent oils as additive concentrates or packages. Additive concentrate encompasses component concentrates as well as additive packages. Often in making or formulating functional fluid, viscosity modifiers or viscosity index improvers may be used individually as components or concentrates, independent of the use of other performance additives in the form of components, concentrates, or packages. The amount and type of performance additives that may be combined with the base oils recited herein are limited such that the functional fluid composition comprising this total base oil mixture and one or more performance additives meet the low volatility performance suitable for internal lubricants for sintered metal materials and bearings.

This invention is surprisingly advantageous in applications where low-temperature properties are important to the performance of the finished lube or functional fluid. The base stocks and base oils recited herein may be advantageously used in many of the following applications, for example hydraulic fluids, compressor oils, turbine oils, circulating oils, gear oils, paper machine oils, industrial oils, automotive oils, manual transmission fluids, automatic transmission fluids, drive train fluids, engine oils, gas engine oils, aviation piston oils, diesel oils, marine oils, greases, and the like.

One embodiment of this invention encompasses an additive concentrate comprising the base oil with the properties described herein and one or more performance additives. An additive concentrate comprising the base oils may encompass compositions where the base oil is used in concentrations of from about 1 wt % to 99 wt %, preferably from about 5 wt % to 95 wt %, and more preferably from about 10 wt % to 90 wt %. In some particular instances, an additive concentrate comprising the base oils may encompass compositions where the base oil is used in concentrations of from about 20 wt % to 80 wt %, and sometime from about 30 wt % to 70 wt %. Mixtures of the base oilsand co-bases oils are also aspects of suitable additive concentrates.

Process

The products that derive from the processes of this invention demonstrate not only unique combinations of physical properties, but demonstrate unique compositional properties that distinguish and differentiate them from available commercial products. Thus, the base stocks and base oils recited herein derived from the processes recited herein are expected to have unique chemical, compositional, molecular, and structural features that uniquely define the base stocks and base oils recited herein.

The base stocks and base oils recited herein are made according to processes comprising the conversion of waxy feedstocks to produce oils of lubricating viscosity having high viscosity indices and produced in high yields. Thus, one may obtain base stocks and base oils or base stocks having VIs of at least 130, preferably at least 135, more preferably at least 140, and having excellent low-temperature properties. Base stocks made according to these processes meet the requirements of a Group III base stock and can be prepared in high yields while at the same time possessing excellent properties such as high VI and low pour point.

The waxy feedstock used in these processes may derive from natural or mineral or synthetic sources. The feed to this process mays have a waxy paraffins content of at least 50% by weight, preferably at least 70% by weight, and more preferably at least 80% by weight. Preferred synthetic waxy feedstocks generally have waxy paraffins content by weight of at least 90 wt %, often at least 95 wt %, and in some instances at least 97 wt %. In addition, the waxy feed stock used in these processes to make the base stocks and base oils recited herein may comprise one or more individual natural, mineral, or synthetic waxy feedstocks, or any mixture thereof.

In addition, feedstocks to these processes may be either taken from conventional mineral oils, or synthetic processes. For example, synthetic processes may include GTL (gas-to-liquids) or FT (Fischer-Tropsch) hydrocarbons produced by such processes as the Fischer-Tropsch process or the Kolbel-Englehardt process. Many of the preferred feedstocks are characterized as having predominantly saturated (paraffinic) compositions.

In more detail, the feedstock used in the process of the invention are wax-containing feeds that boil in the lubricating oil range, typically having a 10% distillation point greater than 650° F. (343° C.), measured by ASTM D 86 or ASTM 2887, and are derived from mineral or synthetic sources. The wax content of the feedstock is at least about 50 wt. %, based on feedstock and can range up to 100 wt. % wax. The wax content of a feed may be determined by nuclear magnetic resonance spectroscopy (ASTM D5292), by correlative ndM methods (ASTM D3238) or by solvent means (ASTM D3235). The waxy feeds may be derived from a number of sources such as natural or mineral or synthetic. In particular, waxy feeds may include, for example, oils derived from solvent refining processes such as raffinates, partially solvent dewaxed oils, deasphalted oils, distillates, vacuum gas oils, coker gas oils, slack waxes, foots oils and the like, and Fischer-Tropsch waxes. Preferred feeds are slack waxes and Fischer-Tropsch waxes. Slack waxes are typically derived from hydrocarbon feeds by solvent or propane dewaxing. Slack waxes contain some residual oil and are typically deoiled. Foots oils are derived from deoiled slack waxes. The Fischer-Tropsch synthetic process prepares Fischer-Tropsch waxes. Non limiting examples of suitable waxy feedstocks include Paraflint 80 (a hydrogenated Fischer-Tropsch wax) and Shell MDS Waxy Raffinate (a hydrogenated and partially isomerized middle distillate synthesis waxy raffinate.)

Feedstocks may have high contents of nitrogen- and sulfur-contaminants. Feeds containing up to 0.2 wt. % of nitrogen, based on feed and up to 3.0 wt. % of sulfur can be processed in the present process. Feeds having a high wax content typically have high viscosity indexes of up to 200 or more. Sulfur and nitrogen contents may be measured by standard ASTM methods D5453 and D4629, respectively.

For feeds derived from solvent extraction, the high boiling petroleum fractions from atmospheric distillation are sent to a vacuum distillation unit, and the distillation fractions from this unit are solvent extracted. The residue from vacuum distillation may be deasphalted. The solvent extraction process selectively is dissolves the aromatic components in an extract phase while leaving the more paraffinic components in a raffinate phase. Naphthenes are distributed between the extract and raffinate phases. Typical solvents for solvent extraction include phenol, furfural and N-methyl pyrrolidone. By controlling the solvent to oil ratio, extraction temperature and method of contacting distillate to be extracted with solvent, one can control the degree of separation between the extract and raffinate phases.

Hydrotreating

For hydrotreating, the catalysts are those effective for hydrotreating such as catalysts containing Group 6 metals (based on the IUPAC Periodic Table format having Groups from 1 to 18), Groups 8-10 metals, and mixtures thereof. Preferred metals include nickel, tungsten, molybdenum, cobalt and mixtures thereof. These metals or mixtures of metals are typically present as oxides or sulfides on refractory metal oxide supports. The mixture of metals may also be present as bulk metal catalysts wherein the amount of metal is 30 wt. % or greater, based on catalyst. Suitable metal oxide supports include oxides such as silica, alumina, silica-aluminas or titania, preferably alumina. Preferred aluminas are porous aluminas such as gamma or beta. The amount of metals, either individually or in mixtures, ranges from about 0.5 to 35 wt. %, based on the catalyst. In the case of preferred mixtures of groups 9-10 metals with group 6 metals, the groups 9-10 metals are present in amounts of from 0.5 to 5 wt. %, based on catalyst and the group 6 metals are present in amounts of from 5 to 30 wt. %. The amounts of metals may be measured by atomic absorption spectroscopy, inductively coupled plasma-atomic emission spectrometry or other methods specified by ASTM for individual metals.

The acidity of metal oxide supports can be controlled by adding promoters and/or dopants, or by controlling the nature of the metal oxide support, e.g., by controlling the amount of silica incorporated into a silica-alumina support. Examples of promoters and/or dopants include halogen, especially fluorine, phosphorus, boron, yttria, rare-earth oxides and magnesia. Promoters such as halogens generally increase the acidity of metal oxide supports while mildly basic dopants such as yttria or magnesia tend to decrease the acidity of such supports.

Hydrotreating conditions include temperatures of from 150 to 400° C., preferably 200 to 350° C., a hydrogen partial pressure of from 1480 to 20786 kPa (200 to 3000 psig), preferably 2859 to 13891 kPa (400 to 2000 psig), a space velocity of from 0.1 to 10 liquid hourly space velocity (LHSV), preferably 0.1 to 5 LHSV, and a hydrogen to feed ratio of from 89 to 1780 m³/m³ (500 to 10000 scf/B), preferably 178 to 890 m³/m³.

Hydrotreating reduces the amount of nitrogen- and sulfur-containing contaminants to levels which will not unacceptably affect the dewaxing catalyst in the subsequent dewaxing step. Also, there may be certain polynuclear aromatic species which will pass through the present mild hydrotreating step. These contaminants, if present, will be removed in a subsequent hydrofinishing step.

During hydrotreating, less than 5 wt. % of the feedstock, preferably less than 3 wt. %, more preferably less than 2 wt. %, is converted to 650° F. (343° C.) minus products to produce a hydrotreated feedstock whose VI increase is less than 4, preferably less than 3, more preferably less than 2 greater than the VI of the feedstock. The high wax contents of the present feeds results in minimal VI increase during the hydrotreating step.

The hydrotreated feedstock may be passed directly to the dewaxing step or preferably, stripped to remove gaseous contaminants such as hydrogen sulfide and ammonia prior to dewaxing. Stripping can be by conventional means such as flash drums or fractionators

Dewaxing Catalyst

The dewaxing catalyst may be either crystalline or amorphous. Crystalline materials are molecular sieves that contain at least one 10 or 12 ring channel and may be based on aluminosilicates (zeolites) or on silicoaluminophosphates (SAPOs). Zeolites used for oxygenate treatment may contain at least one 10 or 12 channel. Examples of such zeolites include ZSM-22, ZSM-23, ZSM-35, ZSM-48, ZSM-57, ferrierite, ITQ-13, MCM-68 and MCM-71. Examples of aluminophosphates containing at least one 10 ring channel include ECR-42. Examples of molecular sieves containing 12 ring channels include zeolite beta, and MCM-68. The molecular sieves are described in U.S. Pat. Nos. 5,246,566, 5,282,958, 4,975,177, 4,397,827, 4,585,747, 5,075,269 and 4,440,871. MCM-68 is described in U.S. Pat. No. 6,310,265. MCM-71 and ITQ-13 are described in PCT published applications WO 0242207 and WO 0078677. ECR-42 is disclosed in U.S. Pat. No. 6,303,534. Preferred catalysts include ZSM-48, ZSM-22 and ZSM-23. Especially preferred is ZSM-48. The molecular sieves are preferably in the hydrogen form. Reduction can occur in situ during the dewaxing step itself or can occur ex situ in another vessel.

Amorphous dewaxing catalysts include alumina, fluorided alumina, silica-alumina, fluorided silica-alumina and silica-alumina doped with Group 3 metals. Such catalysts are described for example in U.S. Pat. Nos. 4,900,707 and 6,383,366.

The dewaxing catalysts are bifunctional, i.e., they are loaded with a metal hydrogenation component, which is at least one Group 6 metal, at least one Group 8-10 metal, or mixtures thereof. Preferred metals are Groups 9-10 metals. Especially preferred are Groups 9-10 noble metals such as Pt, Pd or mixtures thereof (based on the IUPAC Periodic Table format having Groups from 1 to 18). These metals are loaded at the rate of 0.1 to 30 wt. %, based on catalyst. Catalyst preparation and metal loading methods are described for example in U.S. Pat. No. 6,294,077, and include for example ion exchange and impregnation using decomposable metal salts. Metal dispersion techniques and catalyst particle size control are described in U.S. Pat. No. 5,282,958. Catalysts with small particle size and well dispersed metal are preferred.

The molecular sieves are typically composited with binder materials which are resistant to high temperatures which may be employed under dewaxing conditions to form a finished dewaxing catalyst or may be binderless (self bound). The binder materials are usually inorganic oxides such as silica, alumina, silica-aluminas, binary combinations of silicas with other metal oxides such as titania, magnesia, thoria, zirconia and the like and tertiary combinations of these oxides such as silica-alumina-thoria and silica-alumina magnesia. The amount of molecular sieve in the finished dewaxing catalyst is from 10 to 100, preferably 35 to 100 wt. %, based on catalyst. Such catalysts are formed by methods such spray drying, extrusion and the like. The dewaxing catalyst may be used in the sulfided or unsulfided form, and is preferably in the sulfided form.

Dewaxing conditions include temperatures of from 250-400° C., preferably 275 to 350° C., pressures of from 791 to 20786 kPa (100 to 3000 psig), preferably 1480 to 17339 kPa (200 to 2500 psig), liquid hourly space velocities of from 0.1 to 10 hr⁻¹, preferably 0.1 to 5 hr⁻¹ and hydrogen treat gas rates from 45 to 1780 m³/m³ (250 to 10000 scf/B), preferably 89 to 890 m³/m³ (500 to 5000 scf/B).

Hydrofinishing

At least a portion of the product from dewaxing is passed directly to a hydrofinishing step without disengagement. It is preferred to hydrofinish the product resulting from dewaxing in order to adjust product qualities to desired specifications. Hydrofinishing is a form of mild hydrotreating directed to saturating any lube range olefins and residual aromatics as well as to removing any remaining heteroatoms and color bodies. The post dewaxing hydrofinishing is usually carried out in cascade with the dewaxing step. Generally the hydrofinishing will be carried out at temperatures from about 150° C. to 350° C., preferably 180° C. to 250° C. Total pressures are typically from 2859 to 20786 kPa (about 400 to 3000 psig). Liquid hourly space velocity is typically from 0.1 to 5 LHSV (hr⁻¹), preferably 0.5 to 3 hr⁻¹ and hydrogen treat gas rates of from 44.5 to 1780 m³/m³ (250 to 10,000 scf/B).

Hydrofinishing catalysts are those containing Group 6 metals (based on the IUPAC Periodic Table format having Groups from 1 to 18), Groups 8-10 metals, and mixtures thereof. Preferred metals include at least one noble metal having a strong hydrogenation function, especially platinum, palladium and mixtures thereof. The mixture of metals may also be present as bulk metal catalysts wherein the amount of metal is 30 wt. % or greater based on catalyst. Suitable metal oxide supports include low acidic oxides such as silica, alumina, silica-aluminas or titania, preferably alumina. The preferred hydrofinishing catalysts for aromatics saturation will comprise at least one metal having relatively strong hydrogenation function on a porous support. Typical support materials include amorphous or crystalline oxide materials such as alumina, silica, and silica-alumina. The metal content of the catalyst is often as high as about 20 weight percent for non-noble metals. Noble metals are usually present in amounts no greater than about 1 wt. %.

The hydrofinishing catalyst is preferably a mesoporous material belonging to the M41S class or family of catalysts. The M41S family of catalysts are mesoporous materials having high silica contents whose preparation is further described in J. Amer. Chem. Soc., 1992, 114, 10834. Examples included MCM-41, MCM-48 and MCM-50. Mesoporous refers to catalysts having pore sizes from 15 to 100 Å. A preferred member of this class is MCM-41 whose preparation is described in U.S. Pat. No. 5,098,684. MCM-41 is an inorganic, porous, non-layered phase having a hexagonal arrangement of uniformly-sized pores. The physical structure of MCM-41 is like a bundle of straws wherein the opening of the straws (the cell diameter of the pores) ranges from 15 to 100 Angstroms. MCM-48 has a cubic symmetry and is described for example is U.S. Pat. No. 5,198,203 whereas MCM-50 has a lamellar structure. MCM-41 can be made with different size pore openings in the mesoporous range. The mesoporous materials may bear a metal hydrogenation component which is at least one of Group 8, Group 9 or Group 10 metals. Preferred are noble metals, especially Group 10 noble metals, most preferably Pt, Pd or mixtures thereof.

Generally the hydrofinishing will be carried out at temperatures from about 150° C. to 350° C., preferably 180° C. to 250° C. Total pressures are typically from 2859 to 20786 kPa (about 400 to 3000 psig). Liquid hourly space velocity is typically from 0.1 to 5 LHSV (hr⁻¹), preferably 0.5 to 3 hr⁻¹ and hydrogen treat gas rates of from 44.5 to 1780 m³/m³ (250 to 10,000 scf/B).

In one embodiment, the present invention is directed to a functional fluid comprising at least one base stock with a VI of at least 130 produced by a process which comprises:

(1) hydrotreating a feedstock having a wax content of at least about 60 wt. %, based on feedstock, with a hydrotreating catalyst under effective hydrotreating conditions such that less than 5 wt. % of the feedstock is converted to 650° F. (343° C.) minus products to produce a hydrotreated feedstock whose VI increase is less than 4 greater than the VI of the feedstock;

(2) stripping the hydrotreated feedstock to separate gaseous from liquid product; and

(3) hydrodewaxing the liquid product with a dewaxing catalyst which is at least one of ZSM-48, ZSM-57, ZSM-23, ZSM-22, ZSM-35, ferrierite, ECR-42, ITQ-13, MCM-71, MCM-68, beta, fluorided alumina, silica-alumina or fluorided silica alumina under catalytically effective hydrodewaxing conditions wherein the dewaxing catalyst contains at least one Group 9 or Group 10 noble metal.

Another embodiment of the present invention is directed to a functional fluid comprising at least one base stock with a VI of at least 130 produced by a process which comprises:

(1) hydrotreating a lubricating oil feedstock having a wax content of at least about 50 wt. %, based on feedstock, with a hydrotreating catalyst under effective hydrotreating conditions such that less than 5 wt. % of the feedstock is converted to 650° F. (343° C.) minus products to produce a hydrotreated feedstock to produce a hydrotreated feedstock whose VI increase is less than 4 greater than the VI of the feedstock;

(2) stripping the hydrotreated feedstock to separate gaseous from liquid product;

(3) hydrodewaxing the liquid product with a dewaxing catalyst which is at least one of ZSM-22, ZSM-23, ZSM-35, ferrierite, ZSM-48, ZSM-57, ECR-42, ITQ-13, MCM-68, MCM-71, beta, fluorided alumina, silica-alumina or fluorided silica-alumina under catalytically effective hydrodewaxing conditions wherein the dewaxing catalyst contains at least one Group 9 or 10 noble metal; and

(4) hydrofinishing the product from step (3) with a mesoporous hydrofinishing catalyst from the M41S family under hydrofinishing conditions.

Another embodiment of the present invention is directed to a functional fluid comprising at least one base stock with a VI of at least 130 produced by a process which comprises:

(1) hydrotreating a lubricating oil feedstock having a wax content of at least about 60 wt. %, based on feedstock, with a hydrotreating catalyst under effective hydrotreating conditions such that less than 5 wt. % of the feedstock is converted to 650° F. (343° C.) minus products to produce a hydrotreated feedstock to produce a hydrotreated feedstock whose VI increase is less than 4 greater than the VI of the feedstock;

(2) stripping the hydrotreated feedstock to separate gaseous from liquid product;

(3) hydrodewaxing the liquid product with a dewaxing catalyst which is ZSM-48 under catalytically effective hydrodewaxing conditions wherein the dewaxing catalyst contains at least one Group 9 or 10 noble metal; and

(a) Optionally, hydrofinishing the product from step (3) with MCM-41 under hydrofinishing conditions.

Additional details concerning the processes that make the current invention may be found in co-pending application U.S. S No. 60/416,865 which is hereby incorporated by reference in its entirety.

Base Stocks and Base Oils

A wide range of base stocks and base oils are known in the art. Base stocks and base oils that may be used as co-base stocks or co-base oils in combination with the base stocks and base oils of the present invention are natural oils, mineral oils, and synthetic oils. These base stocks and base oils may be used individually or in any combination of mixtures with the instant invention. Natural, mineral, and synthetic oils (or mixtures thereof) may be used unrefined, refined, or rerefined (the latter is also known as reclaimed or reprocessed oil). Unrefined oils are those obtained directly from a natural, mineral, or synthetic source and used without added purification. These include shale oil obtained directly from retorting operations, petroleum oil obtained directly from primary distillation, and ester oil obtained directly from an esterification process. Refined oils are similar to the oils discussed for unrefined oils except refined oils are subjected to one or more purification steps to improve the at least one lubricating oil property. One skilled in the art is familiar with many purification processes. These processes include for example solvent extraction, distillation, secondary distillation, acid extraction, base extraction, filtration, percolation, dewaxing, hydroisomerization, hydrocracking, hydrofinishing, and others. Rerefined oils are obtained by processes analogous to refined oils but using an oil that has been previously used.

Groups I, II, III, IV and V are broad categories of base oil stocks developed and defined by the American Petroleum Institute (API Publication 1509; www.API.org) to create guidelines for base stocks and base oils. Group I base stock generally have a viscosity index of between about 80 to 120 and contains greater than about 0.03 wt % sulfur and/or less than about 90% saturates. Group II base stocks generally have a viscosity index of between about 80 to 120, and contain less than or equal to about 0.03 wt % sulfur and greater than or equal to about 90% saturates. Group III stock generally has a viscosity index greater than about 120 and contain less than or equal to about 0.03 wt % sulfur and greater than about 90% saturates. Group IV includes polyalphaolefins (PAO). Group V base stock includes base stocks not included in Groups I-IV. The table below summarizes properties of each of these five Groups.

TABLE 1
API Classification of Base stocks and base oils

| | Saturates | | | |
|---|---|---|---|---|
| | (wt %) | Sulfur (wt %) | | Viscosity Index |
| Group I | <90 &/or | >0.03% | & | ≧80 & <120 |
| Group II | ≧90 & | ≦0.03% | & | ≧80 & <120 |
| Group III | ≧90 & | ≦0.03% | & | ≧120 |

| | |
|---|---|
| Group IV | Polyalphaolefins (PAO) |
| Group V | All other base stocks and base oils not included in |
| | Groups I, II, III, or IV |

Base stocks and base oils may be derived from many sources. Natural oils include animal oils, vegetable oils (castor oil and lard oil, for example), and mineral oils. In regard to animal and vegetable oils, those possessing favorable thermal oxidative stability can be used. Of the natural oils, mineral oils are preferred. Mineral oils vary widely as to their crude source, for example, as to whether they are paraffinic, naphthenic, or mixed paraffinic-naphthenic. Oils derived from coal or shale are also useful in the present invention. Natural oils vary also as to the method used for their production and purification, for example, their distillation range and whether they are straight run or cracked, hydrorefined, or solvent extracted.

Synthetic oils include hydrocarbon oil. Hydrocarbon oils include oils such as polymerized and interpolymerized olefins (polybutylenes, polypropylenes, propylene isobutylene copolymers, ethylene-olefin copolymers, and ethylene-alphaolefin copolymers, polymers or copolymer of hydrocarbyl-substituted olefins where hydrocarbyl optionally contains O, N, or S, for example). Polyalphaolefin (PAO) oil base stocks are a commonly used synthetic hydrocarbon oil. By way of example, PAOs derived from C8, C10, C12, C14 olefins or mixtures thereof may be utilized. See U.S. Pat. Nos. 4,956,122; 4,827,064; and 4,827,073, which are incorporated herein by reference in their entirety.

Group III and PAO base stocks and base oils are typically available in a number of viscosity grades, for example, with kinematic viscosity at 100C of 4 cSt, 5 cSt, 6 cSt, 8 cSt, 10 cSt, 12 cSt, 40 cSt, 100 cSt, and higher, as well as any number of intermediate viscosity grades. In addition, PAO base stocks and base oils with high viscosity-index characteristics are available, typically in higher viscosity grades, for example, with kinematic viscosity at 100C of 100 cSt to 3000 cSt or higher. The number average molecular weights of the PAOs, which are known materials and generally available on a major commercial scale from suppliers such as ExxonMobil Chemical Company, Chevron-Phillips, BP-Amoco, and others, typically vary from about 250 to about 3000. The PAOs are typically comprised of relatively low molecular weight hydrogenated polymers or oligomers of alphaolefins which include, but are not limited to, C2 to about C32 alphaolefins with C8 to about C16 alphaolefins, such as 1-octene, 1-decene, 1-dodecene and the like, being preferred. The preferred polyalphaolefins are poly-1-octene, poly-1-decene and poly-1-dodecene and mixtures thereof and mixed olefin-derived polyolefins. However, the dimers of higher olefins in the range of C14 to C 18 may be used to provide low viscosity basestocks of acceptably low volatility. Depending on the viscosity grade and the starting oligomer, the PAOs may be predominantly trimers and tetramers of the starting olefins, with minor amounts of the higher oligomers, having a viscosity range of about 1.5 to 12 cSt. PAO base stocks and base oils may be used in formulated functional fluids either individually or in any combination of two or more.

The PAO fluids may be conveniently made by the polymerization of an alphaolefin in the presence of a polymerization catalyst such as the Friedel-Crafts catalysts including, for example, aluminum trichloride, boron trifluoride or complexes of boron trifluoride with water, alcohols such as ethanol, propanol or butanol, carboxylic acids or esters such as ethyl acetate or ethyl propionate. For is example the methods disclosed by U.S. Pat. No. 4,149,178 or U.S. Pat. No. 3,382,291 may be conveniently used herein. Other descriptions of PAO synthesis are found in the following U.S. Pat. Nos. 3,742,082; 3,769,363; 3,876,720; 4,239,930; 4,367,352; 4,413,156; 4,434,408; 4,910,355; 4,956,122; and 5,068,487. The dimers of the C14 to C18 olefins are described in U.S. Pat. No. 4,218,330. All of the aforementioned patents are incorporated by reference herein in their entirety.

Other types of synthetic PAO base stocks and base oils include high viscosity index lubricant fluids as described in U.S. Pat. Nos. 4,827,064 and 4,827,073, which can be highly advantageously used in combination with the base stocks and base oils recited hereins, as well as with in the formulated functions fluids of this same invention. Other useful synthetic lubricating oils may also be utilized, for example, those described in the work “Synthetic Lubricants”, Gunderson and hart, Reinhold Publ. Corp., New York, 1962, which is incorporated in its entirety.

Other synthetic base stocks and base oils include hydrocarbon oils that are derived from the oligomerization or polymerization of low-molecular weight compounds whose reactive group is not olefinic, into higher molecular weight compounds, which may be optionally reacted further or chemically modified in additional processes (e.g. isodewaxing, alkylation, esterification, hydroisomerization, dewaxing, etc.) to give a base oil of lubricating viscosity.

Hydrocarbyl aromatic base stocks and base oils are also widely used in lubrication oils and functional fluids. In alkylated aromatic stocks (hydrocarbyl aromatics, for example), the alkyl substituents are typically alkyl groups of about 8 to 25 carbon atoms, usually from about 10 to 18 carbon atoms and up to three such substituents may be present, as described for the alkyl benzenes in ACS Petroleum Chemistry Preprint 1053-1058, “Poly n-Alkylbenzene Compounds: A Class of Thermally Stable and Wide Liquid Range Fluids”, Eapen et al, Phila. 1984. Tri-alkyl benzenes may be produced by the cyclodimerization of 1-alkynes of 8 to 12 carbon atoms as described in U.S. Pat. No. 5,055,626. Other alkylbenzenes are described in European Patent Application No. 168534 and U.S. Pat. No. 4,658,072. Alkylbenzenes are used as lubricant basestocks, especially for low-temperature applications (arctic vehicle service and refrigeration oils) and in papermaking oils. They are commercially available from producers of linear alkylbenzenes (LABs) such as Vista Chem. Co, Huntsman Chemical Co., Chevron Chemical Co., and Nippon Oil Co. The linear alkylbenzenes typically have good low pour points and low temperature viscosities and VI values greater than 100 together with good solvency for additives. Other alkylated aromatics which may be used when desirable are described, for example, in “Synthetic Lubricants and High Performance Functional Fluids”, Dressler, H., chap 5, (R. L. Shubkin (Ed.)), Marcel Dekker, N.Y. 1993. Aromatic base stocks and base oils may include, for example, hydrocarbyl alkylated derivatives of benzene, naphthalene, biphenyls, di-aryl ethers, di-aryl sulfides, di-aryl sulfones, di-aryl sulfoxides, di-aryl methanes or ethanes or propanes or higher homologues, mono- or di- or tri-aryl heterocyclic compounds containing one or more 0, N, S, or P.

The hydrocarbyl aromatics that can be used can be any hydrocarbyl molecule that contains at least about 5% of its weight derived from an aromatic moiety such as a benzenoid moiety or naphthenoid moiety, or their derivatives. These hydrocarbyl aromatics include alkyl benzenes, alkyl naphthalenes, alkyl diphenyl oxides, alkyl naphthols, alkyl diphenyl sulfides, alkylated bis-phenol A, alkylated thiodiphenol, and the like. The aromatic can be mono-alkylated, dialkylated, polyalkylated, and the like. The aromatic can be mono- or poly-functionalized. The hydrocarbyl groups can also be comprised of mixtures of alkyl groups, alkenyl groups, alkynyl, cycloalkyl groups, cycloalkenyl groups and other related hydrocarbyl groups. The hydrocarbyl groups can range from about C6 up to about C60 with a range of about C8 to about C40 often being preferred. A mixture of hydrocarbyl groups is often preferred. The hydrocarbyl group can optionally contain sulfur, oxygen, and/or nitrogen containing substituents. The aromatic group can also be derived from natural (petroleum) sources, provided at least about 5% of the molecule is comprised of an above-type aromatic moiety. Viscosities at 10° C. of approximately 3 cSt to about 50 cSt are preferred, with viscosities of approximately 3.4 cSt to about 20 cSt often being more preferred for the hydrocarbyl aromatic component. In one embodiment, an alkyl naphthalene where the alkyl group is primarily comprised of 1-hexadecene is used. Other alkylates of aromatics can be advantageously used. Naphthalene, for example, can be alkylated with olefins such as octene, decene, dodecene, tetradecene or higher, mixtures of similar olefins, and the like. Useful concentrations of hydrocarbyl aromatic in a lubricant oil composition can be about 2% to about 25%, preferably about 4% to about 20%, and more preferably about 4% to about 15%, depending on the application.

Other useful lubricant oil base stocks include wax isomerate base stocks and base oils, comprising hydroisomerized waxy stocks (e.g. waxy stocks such as gas oils, slack waxes, fuels hydrocracker bottoms, etc.), hydroisomerized Fischer-Tropsch waxes, Gas-to-Liquids (GTL) base stocks and base oils, and other wax isomerate hydroisomerized base stocks and base oils, or mixtures thereof. Fischer-Tropsch waxes, the high boiling point residues of Fischer-Tropsch synthesis, are highly paraffinic hydrocarbons with very low sulfur content. The hydroprocessing used for the production of such base stocks may use an amorphous hydrocracking/hydroisomerization catalyst, such as one of the specialized lube hydrocracking (LHDC) catalysts or a crystalline hydrocracking/hydroisomerization catalyst, preferably a zeolitic catalyst. For example, one useful catalyst is ZSM-48 as described in U.S. Pat. No. 5,075,269. Processes for making hydrocracked/hydroisomerized distillates and hydrocracked/hydroisomerized waxes are described, for example, in U.S. Pat. Nos. 2,817,693; 4,975,177; 4,921,594 and 4,897,178 as well as in British Patent Nos. 1,429,494; 1,350,257; 1,440,230 and 1,390,359. Particularly favorable processes are described in European Patent Application Nos. 464546 and 464547. Processes using Fischer-Tropsch wax feeds are described in U.S. Pat. No. 4,594,172 and 4,943,672. Gas-to-Liquids (GTL) base stocks and base oils, Fischer-Tropsch wax derived base stocks and base oils, and other wax isomerate hydroisomerized (wax isomerate) base stocks and base oils be advantageously used in the instant invention, and may have useful kinematic viscosities at 100C of about 3 cSt to about 50 cSt, preferably about 3 cSt to about 30 cSt, more preferably about 3.5 cSt to about 25 cSt, as exemplified by GTL4 with kinematic viscosity of about 3.8 cSt at 100C and a viscosity index of about 138. These Gas-to-Liquids (GTL) base stocks and base oils, Fischer-Tropsch wax derived base stocks and base oils, and other wax isomerate hydroisomerized base stocks and base oils may have useful pour points of about −20C or lower, and under some conditions may have advantageous pour points of about −25C or lower, with useful pour points of about −30C to about −40C or lower. Useful compositions of Gas-to-Liquids (GTL) base stocks and base oils, Fischer-Tropsch wax derived base stocks and base oils, and wax isomerate hydroisomerized base stocks and base oils are recited in U.S. Pat. Nos. 6,080,301; 6,090,989, and 6,165,949 for example, and are incorporated herein in their entirety by reference.

Gas-to-Liquids (GTL) base stocks and base oils, Fischer-Tropsch wax derived base stocks and base oils, have a beneficial kinematic viscosity advantage over conventional Group II and Group III base stocks and base oils, which may be used as a co-base stock or co-base oil with the instant invention. Gas-to-Liquids (GTL) base stocks and base oils can have significantly higher kinematic viscosities, up to about 20-50 cSt at 100C, whereas by comparison commercial Group II base stocks and base oils can have kinematic viscosities, up to about 15 cSt at 100C, and commercial Group III base stocks and base oils can have kinematic viscosities, up to about 10 cSt at 100C. The higher kinematic viscosity range of Gas-to-Liquids (GTL) base stocks and base oils, compared to the more limited kinematic viscosity range of Group II and Group III base stocks and base oils, in combination with the instant invention can provide additional beneficial advantages in formulating lubricant compositions. Also, the exceptionally low sulfur content of Gas-to-Liquids (GTL) base stocks and base oils, and other wax isomerate hydroisomerized base stocks and base oils, in combination with the low sulfur content of suitable olefin oligomers and/or alkyl aromatics base stocks and base oils, and in combination with the instant invention can provide additional advantages in lubricant compositions where very low overall sulfur content can beneficially impact lubricant performance.

Alkylene oxide polymers and interpolymers and their derivatives containing modified terminal hydroxyl groups obtained by, for example, esterification or etherification are useful synthetic lubricating oils. By way of example, these oils may be obtained by polymerization of ethylene oxide or propylene oxide, the alkyl and aryl ethers of these polyoxyalkylene polymers (methyl-polyisopropylene glycol ether having an average molecular weight of about 1000, diphenyl ether of polyethylene glycol having a molecular weight of about 500-1000, and the diethyl ether of polypropylene glycol having a molecular weight of about 1000 to 1500, for example) or mono- and polycarboxylic esters thereof (the acidic acid esters, mixed C3-8 fatty acid esters, or the C13Oxo acid diester of tetraethylene glycol, for example).

Esters comprise a useful base stock. Additive solvency and seal compatibility characteristics may be secured by the use of esters such as the esters of dibasic acids with monoalkanols and the polyol esters of monocarboxylic acids. Esters of the former type include, for example, the esters of dicarboxylic acids such as phthalic acid, succinic acid, alkyl succinic acid, alkenyl succinic acid, maleic acid, azelaic acid, suberic acid, sebacic acid, fumaric acid, adipic acid, linoleic acid dimer, malonic acid, alkyl malonic acid, alkenyl malonic acid, etc., with a variety of alcohols such as butyl alcohol, hexyl alcohol, dodecyl alcohol, 2-ethylhexyl alcohol, etc. Specific examples of these types of esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, etc.

Particularly useful synthetic esters are those which are obtained by reacting one or more polyhydric alcohols, preferably the hindered polyols (such as the neopentyl polyols e.g. neopentyl glycol, trimethylol ethane, 2-methyl-2-propyl-1,3-propanediol, trimethylol propane, pentaerythritol and dipentaerythritol) with alkanoic acids containing at least about 4 carbon atoms such as C5 to C30 acids (such as saturated straight chain fatty acids including caprylic acid, capric acid, lauric acid, myristic acid, palmitic acid, stearic acid, arachic acid, and behenic acid, or the corresponding branched chain fatty acids or unsaturated fatty acids such as oleic acid, or mixtures thereof).

Suitable synthetic ester components include esters of trimethylol propane, trimethylol butane, trimethylol ethane, pentaerythritol and/or dipentaerythritol with one or more monocarboxylic acids containing from about 5 to about 10 carbon atoms. Such esters are widely available commercially, for example, the Mobil P-41 and P-51 esters (ExxonMobil Chemical Company).

Other esters may included natural esters and their derivatives, fully esterified or partially esterified, optionally with free hydroxyl or carboxyl groups. Such ester may included glycerides, natural and/or modified vegetable oils, derivatives of fatty acids or fatty alcohols.

Silicon-based oils are another class of useful synthetic lubricating oils. These oils include polyalkyl-, polyaryl-, polyalkoxy-, and polyaryloxy-siloxane oils and silicate oils. Examples of suitable silicon-based oils include tetraethyl silicate, tetraisopropyl silicate, tetra-(2-ethylhexyl)silicate, tetra-(4-methylhexyl)silicate, tetra-(p-tert-butylphenyl) silicate, hexyl-(4-methyl-2-pentoxy) disiloxane, poly(methyl) siloxanes, and poly-(methyl-2-mehtylphenyl) siloxanes.

Another class of synthetic lubricating oil is esters of phosphorus-containing acids. These include, for example, tricresyl phosphate, trioctyl phosphate, diethyl ester of decanephosphonic acid.

Another type of base stocks and base oils includes polymeric tetrahydrofurans and the like, and their derivatives where reactive pendant or end groups are partially or fully derivatized or capped with suitable hydrocarbyl groups which may optionally contain O, N, or S.

The highly beneficial viscosity advantages of the base stocks and base oils recited herein can be realized in combination with one or more performance additives, and with the desirable measured-to-theoretical viscosity ratios at less than −25C, preferably at −30C or lower, being realized in the resulting formulated functional fluid. These functional fluid also have the unique and highly desirable characteristic of a measured-to-theoretical viscosity ratio of 1.2 or lower, preferably 1.16 or lower, and in many instances more preferably 1.12 or lower. Thus the effect of the measured-to-theoretical viscosity feature of the base stocks and base oils recited herein is preserved even in the presence of performance additives, leading to improved formulated functional fluid comprising the base stocks and base oils recited herein and one or more performance additives.

Performance Additives

The instant invention can be used with additional lubricant components in effective amounts in lubricant compositions, such as for example polar and/or non-polar lubricant base oils, and performance additives such as for example, but not limited to, metallic and ashless oxidation inhibitors, metallic and ashless dispersants, metallic and ashless detergents, corrosion and rust inhibitors, metal deactivators, anti-wear agents (metallic and non-metallic, low-ash, phosphorus-containing and non-phosphorus, sulfur-containing and non-sulfur types), extreme pressure additives (metallic and non-metallic, phosphorus-containing and non-phosphorus, sulfur-containing and non-sulfur types), anti-seizure agents, pour point depressants, wax modifiers, viscosity index improvers, viscosity modifiers, seal compatibility agents, friction modifiers, lubricity agents, anti-staining agents, chromophoric agents, defoamants, demulsifiers, and others. For a review of many commonly used additives see Klamann in Lubricants and Related Products, Verlag Chemie, Deerfield Beach, Fla.; ISBN 0-89573-177-0, which also gives a good discussion of a number of the lubricant additives discussed mentioned below. Reference is also made “Lubricant Additives” by M. W. Ranney, published by Noyes Data Corporation of Parkridge, N.J. (1973). In particular, the base oils recited herein can show significant performance advantages with modern additives and/or additive systems, and additive packages that impart characteristics of low sulfur, low phosphorus, and/or low ash to formulated functional fluid.

Anitwear and Extreme Pressure Additives

Additional antiwear additives may be used with the present invention. While there are many different types of antiwear additives, for several decades the principal antiwear additive for internal combustion engine crankcase oils is a metal alkylthiophosphate and more particularly a metal dialkyldithiophosphate in which the primary metal constituent is zinc, or zinc dialkyldithiophosphate (ZDDP). ZDDP compounds generally are of the formula Zn[SP(S)(OR¹)(OR²)]₂ where R¹ and R² are C₁-C₁₈ alkyl groups, preferably C₂-C₁₂ alkyl groups. These alkyl groups may be straight chain or branched. For example, suitable alkyl groups include isopropyl, 4-methyl-2-pentyl, and isooctyl. The ZDDP is typically used in amounts of from about 0.4 wt % to about 1.4 wt. % of the total lube oil composition, although more or less can often be used advantageously.

However, it is found that the phosphorus from these additives has a deleterious effect on the catalyst in catalytic converters and also on oxygen sensors in automobiles. One way to minimize this effect is to replace some or all of the ZDDP with phosphorus-free antiwear additives.

A variety of non-phosphorus additives are also used as antiwear additives. Sulfurized olefins are useful as antiwear and EP additives. Sulfur-containing olefins can be prepared by sulfurization or various organic materials including aliphatic, arylaliphatic or alicyclic olefinic hydrocarbons containing from about 3 to 30 carbon atoms, preferably 3-20 carbon atoms. The olefinic compounds contain at least one non-aromatic double bond. Such compounds are defined by the formula R³R⁴C═CR⁵R⁶ where each of R³-R⁶ are independently hydrogen or a hydrocarbon radical. Preferred hydrocarbon radicals are alkyl or alkenyl radicals. Any two of R³-R⁶ may be connected so as to form a cyclic ring. Additional information concerning sulfurized olefins and their preparation can be found in U.S. Pat. No. 4,941,984, incorporated by reference herein in its entirety.

The use of polysulfides of thiophosphorus acids and thiophosphorus acid esters as lubricant additives is disclosed in U.S. Pat. Nos. 2,443,264; 2,471,115; 2,526,497; and 2,591,577. Addition of phosphorothionyl disulfides as an antiwear, antioxidant, and EP additives is disclosed in U.S. Pat. No. 3,770,854. Use of alkylthiocarbamoyl compounds (bis(dibutyl)thiocarbamoyl, for example) in combination with a molybdenum compound (oxymolybdenum diisopropylphosphorodithioate sulfide, for example) and a phosphorus ester (dibutyl hydrogen phosphite, for example) as antiwear additives in lubricants is disclosed in U.S. Pat. No. 4,501,678. U.S. Pat. No. 4,758,362 discloses use of a carbamate additive to provide improved antiwear and extreme pressure properties. The use of thiocarbamate as an antiwear additive is disclosed in U.S. Pat. No. 5,693,598. Thiocarbamate/molybdenum complexes such as moly-sulfur alkyl dithiocarbamate trimer complex (R=C₈-C₁₈ alkyl) are also useful antiwear agents. Each of the above mentioned patents is incorporated by reference herein in its entirety.

Esters of glycerol may be used as antiwear agents. For example, mono-, di, and tri-oleates, mono-palmitates and mono-myristates may be used.

ZDDP is combined with other compositions that provide antiwear properties. U.S. Pat. No. 5,034,141 discloses that a combination of a thiodixanthogen compound (octylthiodixanthogen, for example) and a metal thiophosphate (ZDDP, for example) can improve antiwear properties. U.S. Pat. No. 5,034,142 discloses that use of a metal alkyoxyalkylxanthate (nickel ethoxyethylxanthate, for example) and a dixanthogen (diethoxyethyl dixanthogen, for example) in combination with ZDDP improves antiwear properties.

Antiwear additives may be used in an amount of about 0.01 to 6 weight percent, preferably about 0.01 to 4 weight percent.

Viscosity Index Improvers

Viscosity index improvers (also known as VI improvers, viscosity modifiers, or viscosity improvers) provide lubricants with high- and low-temperature operability. These additives impart shear stability at elevated temperatures and acceptable viscosity at low temperatures.

Suitable viscosity index improvers include both low molecular weight and high molecular weight hydrocarbons, polyesters and viscosity index improver dispersants that function as both a viscosity index improver and a dispersant. Typical molecular weights of these polymers are between about 10,000 to 1,000,000, more typically about 20,000 to 500,00, and even more typically between about 50,000 and 200,000.

Examples of suitable viscosity index improvers are polymers and copolymers of methacrylate, butadiene, olefins, or alkylated styrenes. Polyisobutylene is a commonly used viscosity index improver. Another suitable viscosity index improver is polymethacrylate (copolymers of various chain length alkyl methacrylates, for example), some formulations of which also serve as pour point depressants. Other suitable viscosity index improvers include copolymers of ethylene and propylene, hydrogenated block copolymers of styrene and isoprene, and polyacrylates (copolymers of various chain length acrylates, for example). Specific examples include styrene-isoprene or styrene-butadiene based polymers of about 50,000 to 200,000 molecular weight.

Viscosity index improvers may be used in an amount of about 0.01 to 15 weight percent, preferably about 0.01 to 10 weight percent, and in some instances, more preferably about 0.01 to 5 weight percent.

Antioxidants

Antioxidants retard the oxidative degradation of base oils during service. Such degradation may result in deposits on metal surfaces, the presence of sludge, or a viscosity increase in the lubricant. One skilled in the art knows a wide variety of oxidation inhibitors that are useful in lubricating oil compositions. See, Klamann in Lubricants and Related Products, op cite, and U.S. Pat. Nos. 4,798,684 and 5,084,197, for example, the disclosures of which are incorporated by reference herein in their entirety. Useful antioxidants include hindered phenols. These phenolic antioxidants may be ashless (metal-free) phenolic compounds or neutral or basic metal salts of certain phenolic compounds. Typical phenolic antioxidant compounds are the hindered phenolics which are the ones which contain a sterically hindered hydroxyl group, and these include those derivatives of dihydroxy aryl compounds in which the hydroxyl groups are in the o- or p-position to each other. Typical phenolic antioxidants include the hindered phenols substituted with C₆+ alkyl groups and the alkylene coupled derivatives of these hindered phenols. Examples of phenolic materials of this type 2-t-butyl-4-heptyl phenol; 2-t-butyl-4-octyl phenol; 2-t-butyl-4-dodecyl phenol; 2,6-di-t-butyl-4-heptyl phenol; 2,6-di-t-butyl-4-dodecyl phenol; 2-methyl-6-t-butyl-4-heptyl phenol; and 2-methyl-6-t-butyl-4-dodecyl phenol. Other useful hindered mono-phenolic antioxidants may include for example hindered 2,6-di-alkyl-phenolic proprionic ester derivatives. Bis-phenolic antioxidants may also be advantageously used in combination with the instant invention. Examples of ortho coupled phenols include: 2,2′-bis(6-t-butyl-4-heptyl phenol); 2,2′-bis(6-t-butyl-4-octyl phenol); and 2,2′-bis(6-t-butyl-4-dodecyl phenol). Para coupled bis phenols include for example 4,4′-bis(2,6-di-t-butyl phenol) and 4,4′-methylene-bis(2,6-di-t-butyl phenol).

Non-phenolic oxidation inhibitors which may be used include aromatic amine antioxidants and these may be used either as such or in combination with phenolics. Typical examples of non-phenolic antioxidants include: alkylated and non-alkylated aromatic amines such as aromatic monoamines of the formula R⁸R⁹R¹⁰N where R⁸ is an aliphatic, aromatic or substituted aromatic group, R⁹ is an aromatic or a substituted aromatic group, and R¹⁰ is H, alkyl, aryl or R¹¹S(O)ₓR¹² where R¹¹ is an alkylene, alkenylene, or aralkylene group, R¹² is a higher alkyl group, or an alkenyl, aryl, or alkaryl group, and x is 0, 1 or 2. The aliphatic group R⁸ may contain from 1 to about 20 carbon atoms, and preferably contains from 6 to 12 carbon atoms. The aliphatic group is a saturated aliphatic group. Preferably, both R⁸ and R⁹ are aromatic or substituted aromatic groups, and the aromatic group may be a fused ring aromatic group such as naphthyl. Aromatic groups R⁸ and R⁹ may be joined together with other groups such as S.

Typical aromatic amines antioxidants have alkyl substituent groups of at least about 6 carbon atoms. Examples of aliphatic groups include hexyl, heptyl, octyl, nonyl, and decyl. Generally, the aliphatic groups will not contain more than about 14 carbon atoms. The general types of amine antioxidants useful in the present compositions include diphenylamines, phenyl naphthylamines, phenothiazines, imidodibenzyls and diphenyl phenylene diamines. Mixtures of two or more aromatic amines are also useful. Polymeric amine antioxidants can also be used. Particular examples of aromatic amine antioxidants useful in the present invention include: p,p′-dioctyldiphenylamine; t-octylphenyl-alpha-naphthylamine; phenyl-alphanaphthylamine; and p-octylphenyl-alpha-naphthylamine.

Sulfurized alkyl phenols and alkali or alkaline earth metal salts thereof also are useful antioxidants. Low sulfur peroxide decomposers are useful as antioxidants.

Another class of antioxidant used in lubricating oil compositions is oil-soluble copper compounds. Any oil-soluble suitable copper compound may be blended into the lubricating oil. Examples of suitable copper antioxidants include copper dihydrocarbyl thio or dithio-phosphates and copper salts of carboxylic acid (naturally occurring or synthetic). Other suitable copper salts include copper dithiacarbamates, sulphonates, phenates, and acetylacetonates. Basic, neutral, or acidic copper Cu(I) and or Cu(II) salts derived from alkenyl succinic acids or anhydrides are know to be particularly useful.

Preferred antioxidants include hindered phenols, arylamines, low sulfur peroxide decomposers and other related components. These antioxidants may be used individually by type or in combination with one another. Such additives may be used in an amount of about 0.01 to 5 weight percent, preferably about 0.01 to 2 weight percent.

Detergents

Detergents are commonly used in lubricating compositions. A typical detergent is an anionic material that contains a long chain oleophillic portion of the molecule and a smaller anionic or oleophobic portion of the molecule. The anionic portion of the detergent is typically derived from an organic acid such as a sulfur acid, carboxylic acid, phosphorus acid, phenol, or mixtures thereof. The counter ion is typically an alkaline earth or alkali metal.

Salts that contain a substantially stochiometric amount of the metal are described as neutral salts and have a total base number (TBN, as measured by ASTM D2896) of from 0 to 80. Many compositions are overbased, containing large amounts of a metal base that is achieved by reacting an excess of a metal compound (a metal hydroxide or oxide, for example) with an acidic gas (such as carbon dioxide). Useful detergents can be neutral, mildly overbased, or highly overbased.

It is desirable for at least some detergent to be overbased. Overbased detergents help neutralize acidic impurities produced by the combustion process and become entrapped in the oil. Typically, the overbased material has a ratio of metallic ion to anionic portion of the detergent of about 1.05:1 to 50:1 on an equivalent basis. More preferably, the ratio is from about 4:1 to about 25:1. The resulting detergent is an overbased detergent that will typically have a TBN of about 150 or higher, often about 250 to 450 or more. Preferably, the overbasing cation is sodium, calcium, or magnesium. A mixture of detergents of differing TBN can be used in the present invention. Preferred detergents include the alkali or alkaline earth metal salts of sulfates, phenates, carboxylates, phosphates, and salicylates.

Sulfonates may be prepared from sulfonic acids that are typically obtained by sulfonation of alkyl substituted aromatic hydrocarbons. Hydrocarbon examples include those obtained by alkylating benzene, toluene, xylene, naphthalene, biphenyl and their halogenated derivatives (chlorobenzene, chlorotoluene, and chloronaphthalene, for example). The alkylating agents typically have about 3 to 70 carbon atoms. The alkaryl sulfonates typically contain about 9 to about 80 carbon or more carbon atoms, more typically from about 16 to 60 carbon atoms.

Klamann in Lubricants and Related Products, op cit discloses a number of overbased metal salts of various sulfonic acids which are useful as detergents and dispersants in lubricants. The book entitled “Lubricant Additives”, C. V. Smallheer and R. K. Smith, published by the Lezius-Hiles Co. of Cleveland, Ohio (1967), similarly discloses a number of overbased sulfonates which are useful as dispersants/detergents.

Alkaline earth phenates are another useful class of detergent. These detergents can be made by reacting alkaline earth metal hydroxide or oxide (CaO, Ca(OH)₂, BaO, Ba(OH)₂, MgO, Mg(OH)₂, for example) with an alkyl phenol or sulfurized alkylphenol. Useful alkyl groups include straight chain or branched C₁-C₃₀ alkyl groups, preferably, C₄-C₂₀. Examples of suitable phenols include isobutylphenol, 2-ethylhexylphenol, nonylphenol, 1-ethyldecylphenol, and the like. It should be noted that starting alkylphenols may contain more than one alkyl substituent that are each independently straight chain or branched. When a non-sulfurized alkylphenol is used, the sulfurized product may be obtained by methods well known in the art. These methods include heating a mixture of alkylphenol and sulfurizing agent (including elemental sulfur, sulfur halides such as sulfur dichloride, and the like) and then reacting the sulfurized phenol with an alkaline earth metal base.

Metal salts of carboxylic acids are also useful as detergents. These carboxylic acid detergents may be prepared by reacting a basic metal compound with at least one carboxylic acid and removing free water from the reaction product. These compounds may be overbased to produce the desired TBN level. Detergents made from salicylic acid are one preferred class of detergents derived from carboxylic acids. Useful salicylates include long chain alkyl salicylates, where alkyl groups have 1 to about 30 carbon atoms, with 1 to 4 alkyl group per benzenoid nucleus, and with the metal of the compound including alkaline earth metal. Preferred R groups are alkyl chains of at least about C₁₁, preferably C₁₃ or greater. R may be optionally substituted with substituents that do not interfere with the detergent's function. M is preferably, calcium, magnesium, or barium. More preferably, M is calcium.

Hydrocarbyl-substituted salicylic acids may be prepared from phenols by the Kolbe reaction. See U.S. Pat. No. 3,595,791 for additional information on synthesis of these compounds. The metal salts of the hydrocarbyl-substituted salicylic acids may be prepared by double decomposition of a metal salt in a polar solvent such as water or alcohol. Alkaline earth metal phosphates are also used as detergents.

Detergents may be simple detergents or what is known as hybrid or complex detergents. The latter detergents can provide the properties of two detergents without the need to blend separate materials. See U.S. Pat. No. 6,034,039 for example.

Preferred detergents include calcium phenates, calcium sulfonates, calcium salicylates, magnesium phenates, magnesium sulfonates, magnesium salicylates and other related components (including borated detergents). Typically, the total detergent concentration is about 0.01 to about 6 weight percent, preferably, about 0.1 to 4 weight percent.

In addition, non-ionic detergents may be preferably used in lubricating compositions. Such non-ionic detergents may be ashless or low-ash compounds, and may include discrete molecular compounds, as well as oligomeric and/or polymeric compounds.

Dispersants

During engine operation, oil insoluble oxidation byproducts are produced. Dispersants help keep these byproducts in solution, thus diminishing their deposit on metal surfaces. Dispersants may be ashless or ash-forming in nature. Preferably, the dispersant is ashless. So called ashless dispersants are organic materials that form substantially no ash upon combustion. For example, non-metal-containing or borated metal-free dispersants are considered ashless. In contrast, metal-containing detergents discussed above form ash upon combustion.

Suitable dispersants typically contain a polar group attached to a relatively high molecular weight hydrocarbon chain. The polar group typically contains at least one element of nitrogen, oxygen, or phosphorous. Typical hydrocarbon chains contain about 50 to 400 carbon atoms.

Dispersants include phenates, sulfonates, sulfurized phenates, salicylates, naphthenates, stearates, carbamates, thiocarbamates, and phosphorus derivatives. A particularly useful class of dispersants are alkenylsuccinic derivatives, typically produced by the reaction of a long chain substituted alkenyl succinic compound, usually a substituted succinic anhydride, with a polyhydroxy or polyamino compound. The long chain group constituting the oleophilic portion of the molecule which confers solubility in the oil, is normally a polyisobutylene group. Many examples of this type of dispersant are well known. Exemplary U.S. patents describing such dispersants include U.S. Pat. Nos. 3,172,892; 3,2145,707; 3,219,666; 3,316,177; 3,341,542; 3,444,170; 3,454,607; 3,541,012; 3,630,904; 3,632,511; 3,787,374 and 4,234,435. Other types of dispersants are described in U.S. Pat. Nos. 3,036,003; 3,200,107; 3,254,025; 3,275,554; 3,438,757; 3,454,555; 3,565,804; 3,413,347; 3,697,574; 3,725,277; 3,725,480; 3,726,882; 4,454,059; 3,329,658; 3,449,250; 3,519,565; 3,666,730; 3,687,849; 3,702,300; 4,100,082; 5,705,458. A further description of dispersants is also found in European Patent Application No. 471 071. Each of the above noted patents and patent applications is incorporated herein by reference in its entirety.

Hydrocarbyl-substituted succinic acid compounds are well known dispersants. In particular, succinimide, succinate esters, or succinate ester amides prepared by the reaction of hydrocarbon-substituted succinic acid preferably having at least 50 carbon atoms in the hydrocarbon substituent, with at least one equivalent of an alkylene amine, are particularly useful.

Succinimides are formed by the condensation reaction between alkenyl succinic anhydrides and amines. Molar ratios can vary depending on the polyamine. For example, the molar ratio of alkenyl succinic anhydride to TEPA can vary from about 1:1 to about 5:1. Representative examples are shown in U.S. Pat. Nos. 3,087,936; 3,172,892; 3,219,666; 3,272,746; 3,322,670; 3,652,616; 3,948,800; and Canada Pat. No. 1,094,044, each of which is incorporated by reference herein in its entirety.

Succinate esters are formed by the condensation reaction between alkenyl succinic anhydrides and alcohols or polyols. Molar ratios can vary depending on the alcohol or polyol used. For example, the condensation product of an alkenyl succinic anhydride and pentaerythritol is a useful dispersant.

Succinate ester amides are formed by condensation reaction between alkenyl succinic anhydrides and alkanol amines. For example, suitable alkanol amines include ethoxylated polyalkylpolyamines, propoxylated polyalkylpolyamines and polyalkenylpolyamines such as polyethylene polyamines. One example is propoxylated hexamethylenediamine. Representative examples are shown in U.S. Pat. No. 4,426,305, incorporated by reference herein in its entirety.

The molecular weight of the alkenyl succinic anhydrides used in the preceding paragraphs will range between about 800 and 2,500. The above products can be post-reacted with various reagents such as sulfur, oxygen, formaldehyde, carboxylic acids such as oleic acid, and boron compounds such as borate esters or highly borated dispersants. The dispersants can be borated with from about 0.1 to about 5 moles of boron per mole of dispersant reaction product, including those derived from mono-succinimides, bis-succinimides (also known as disuccinimides), and mixtures thereof.

Mannich base dispersants are made from the reaction of alkylphenols, formaldehyde, and amines. See U.S. Pat. No. 4,767,551, incorporated by reference herein in its entirety. Process aids and catalysts, such as oleic acid and sulfonic acids, can also be part of the reaction mixture. Molecular weights of the alkylphenols range from 800 to 2,500. Representative examples are shown in U.S. Pat. Nos. 3,697,574; 3,703,536; 3,704,308; 3,751,365; 3,756,953; 3,798,165; and 3,803,039, which are incorporated herein by reference in its entirety.

Typical high molecular weight aliphatic acid modified Mannich condensation products useful in this invention can be prepared from high molecular weight alkyl-substituted hydroxyaromatics or HN(R)2 group-containing reactants.

Examples of high molecular weight alkyl-substituted hydroxyaromatic compounds are polypropylphenol, polybutylphenol, and other polyalkylphenols. These polyalkylphenols can be obtained by the alkylation, in the presence of an alkylating catalyst, such as BF3, of phenol with high molecular weight polypropylene, polybutylene, and other polyalkylene compounds to give alkyl substituents on the benzene ring of phenol having an average 600-100,000 molecular weight.

Examples of HN(R)2 group-containing reactants are alkylene polyamines, principally polyethylene polyamines. Other representative organic compounds containing at least one HN(R)2 group suitable for use in the preparation of Mannich condensation products are well known and include mono- and di-amino alkanes and their substituted analogs, e.g., ethylamine and diethanol amine; aromatic diamines, e.g., phenylene diamine, diamino naphthalenes; heterocyclic amines, e.g., morpholine, pyrrole, pyrrolidine, imidazole, imidazolidine, and piperidine; melamine and their substituted analogs.

Examples of alkylene polyamide reactants include ethylenediamine, diethylene triamine, triethylene tetraamine, tetraethylene pentaamine, pentaethylene hexamine, hexaethylene heptaamine, heptaethylene octaamine, octaethylene nonaamine, nonaethylene decamine, decaethylene undecamine, and mixtures of such amines. Some preferred compositions correspond to formula H2N-(Z-NH—)nH, where Z is a divalent ethylene and n is 1 to 10 of the foregoing formula. Corresponding propylene polyamines such as propylene diamine and di-, tri-, tetra-, pentapropylene tri-, tetra-, penta- and hexaamines are also suitable reactants. Alkylene polyamines usually are obtained by the reaction of ammonia and dihalo alkanes, such as dichloro alkanes. Thus, the alkylene polyamines obtained from the reaction of 2 to 11 moles of ammonia with 1 to 10 moles of dichloro alkanes having 2 to 6 carbon atoms and the chlorines on different carbons are suitable alkylene polyamine reactants.

Aldehyde reactants useful in the preparation of the high molecular products useful in this invention include aliphatic aldehydes such as formaldehyde (such as paraformaldehyde and formalin), acetaldehyde and aldol (b-hydroxybutyraldehyde, for example). Formaldehyde or a formaldehyde-yielding reactant is preferred.

Hydrocarbyl substituted amine ashless dispersant additives are well known to those skilled in the art. See, for example, U.S. Pat. Nos. 3,275,554; 3,438,757; 3,565,804; 3,755,433, 3,822,209, and 5,084,197, each of which is incorporated by reference in its entirety.

Preferred dispersants include borated and non-borated succinimides, including those derivatives from mono-succinimides, bis-succinimides, and/or mixtures of mono- and bis-succinimides, wherein the hydrocarbyl succinimide is derived from a hydrocarbylene group such as polyisobutylene having a Mn of from about 500 to about 5000 or a mixture of such hydrocarbylene groups. Other preferred dispersants include succinic acid-esters and amides, alkylphenol-polyamine coupled Mannich adducts, their capped derivatives, and other related components. Such additives may be used in an amount of about 0.1 to 20 weight percent, preferably about 0.1 to 8 weight percent.

Other dispersants may include oxygen-containing compounds, such as polyether compounds, polycarbonate compounds, and/or polycarbonyl compounds, as oligomers or polymers, ranging from low molecular weight to high molecular weight.

Friction Modifiers

A friction modifier is any material or materials that can alter the coefficient of friction of any lubricant or fluid containing such material(s). Friction modifiers, also known as friction reducers, or lubricity agents or oiliness agents, and other such agents that change the coefficient of friction of lubricant base oils, formulated lubricant compositions, or functional fluids, may be effectively used in combination with the base oils or lubricant compositions of the present invention if desired. Friction modifiers that lower the coefficient of friction are particularly advantageous in combination with the base oils and lube compositions of this invention. Friction modifiers may include metal-containing compounds or materials as well as ashless compounds or materials, or mixtures thereof. Metal-containing friction modifiers may include metal salts or metal-ligand complexes where the metals may include alkali, alkaline earth, or transition group metals. Such metal-containing friction modifiers may also have low-ash characteristics. Transition metals may include Mo, Sb, Sn, Fe, Cu, Zn, and others. Ligands may include hydrocarbyl derivative of alcohols, polyols, glycerols, partial ester glycerols, thiols, carboxylates, carbamates, thiocarbamates, dithiocarbamates, phosphates, thiophosphates, dithiophosphates, amides, imides, amines, thiazoles, thiadiazoles, dithiazoles, diazoles, triazoles, and other polar molecular functional groups containing effective amounts of O, N, S, or P, individually or in combination. In particular, Mo-containing compounds can be particularly effective such as for example Mo-dithiocarbamates, Mo(DTC), Mo-dithiophosphates, Mo(DTP), Mo-amines, Mo (Am), Mo-alcoholates, Mo-alcohol-amides, etc.

Ashless friction modifiers may have also include lubricant materials that contain effective amounts of polar groups, for example hydroxyl-containing hydrocaryl base oils, glycerides, partial glycerides, glyceride derivatives, and the like. Polar groups in friction modifiers may include hyrdocarbyl groups containing effective amounts of O, N, S, or P, individually or in combination. Other friction modifiers that may be particularly effective include, for example, salts (both ash-containing and ashless derivatives) of fatty acids, fatty alcohols, fatty amides, fatty esters, hydroxyl-containing carboxylates, and comparable synthetic long-chain hydrocarbyl acids, alcohols, amides, esters, hydroxy carboxylates, and the like. In some instances fatty organic acids, fatty amines, and sulfurized fatty acids may be used as suitable friction modifiers.

Useful concentrations of friction modifiers may range from about 0.01 wt % to 10-15 wt % or more, often with a preferred range of about 0.1 wt % to 5 wt %. Concentrations of molybdenum containing materials are often described in terms of Mo metal concentration. Advantageous concentrations of Mo may range from about 10 ppm to 3000 ppm or more, and often with a preferred range of about 20-2000 ppm, and in some instances a more preferred range of about 30-1000 ppm. Friction modifiers of all types may be used alone or in mixtures with the materials of this invention. Often mixtures of two or more friction modifiers, or mixtures of friction modifiers(s) with alternate surface active material(s), are also desirable.

Pour Point Depressants

Conventional pour point depressants (also known as lube oil flow improvers) may be added to the compositions of the present invention if desired. These pour point depressant may be added to lubricating compositions of the present invention to lower the minimum temperature at which the fluid will flow or can be poured. Examples of suitable pour point depressants include polymethacrylates, polyacrylates, polyarylamides, condensation products of haloparaffin waxes and aromatic compounds, vinyl carboxylate polymers, and terpolymers of dialkylfumarates, vinyl esters of fatty acids and allyl vinyl ethers. U.S. Pat. Nos. 1,815,022; 2,015,748; 2,191,498; 2,387,501; 2,655,479; 2,666,746; 2,721,877; 2,721,878; and 3,250,715 describe useful pour point depressants and/or the preparation thereof. Each of these references is incorporated herein in its entirety. Such additives may be used in an amount of about 0.01 to 5 weight percent, preferably about 0.01 to 1.5 weight percent.

Corrosion Inhibitors

Corrosion inhibitors are used to reduce the degradation of metallic parts that are in contact with the lubricating oil composition. Suitable corrosion inhibitors include thiadizoles. See, for example, U.S. Pat. Nos. 2,719,125; 2,719,126; and 3,087,932, which are incorporated herein by reference in their entirety. Such additives may be used in an amount of about 0.01 to 5 weight percent, preferably about 0.01 to 1.5 weight percent.

Seal Compatibility Additives

Seal compatibility agents help to swell elastomeric seals by causing a chemical reaction in the fluid or physical change in the elastomer. Suitable seal compatibility agents for lubricating oils include organic phosphates, aromatic esters, aromatic hydrocarbons, esters (butylbenzyl phthalate, for example), and polybutenyl succinic anhydride. Additives of this type are commercially available. Such additives may be used in an amount of about 0.01 to 3 weight percent, preferably about 0.01 to 2 weight percent.

Anti-Foam Agents

Anti-foam agents may advantageously be added to lubricant compositions. These agents retard the formation of stable foams. Silicones and organic polymers are typical anti-foam agents. For example, polysiloxanes, such as silicon oil or polydimethyl siloxane, provide antifoam properties. Anti-foam agents are commercially available and may be used in conventional minor amounts along with other additives such as demulsifiers; usually the amount of these additives combined is less than 1 percent and often less than 0.1 percent.

Inhibitors and Antirust Additives

Antirust additives (or corrosion inhibitors) are additives that protect lubricated metal surfaces against chemical attack by water or other contaminants. A 5 wide variety of these are commercially available; they are referred to also in Klamann, op. cit.

One type of antirust additive is a polar compound that wets the metal surface preferentially, protecting it with a film of oil. Another type of antirust additive absorbs water by incorporating it in a water-in-oil emulsion so that only the oil touches the metal surface. Yet another type of antirust additive chemically adheres to the metal to produce a non-reactive surface. Examples of suitable additives include zinc dithiophosphates, metal phenolates, basic metal sulfonates, fatty acids and amines. Such additives may be used in an amount of about 0.01 to 5 weight percent, preferably about 0.01 to 1.5 weight percent. Additional types of additives may be further incorporated into functional fluid of this invention, and may include one or more additives such as, for example, demulsifiers, solubilizers, fluidity agents, coloring agents, chromophoric agents, and the like, as required. Further, each additive type may include individual additives or mixtures of additive

Typical Additive Amounts

When lubricating oil compositions contain one or more of the additives discussed above, the additive(s) are blended into the composition in an amount sufficient for it to perform its intended function. Typical amounts of such additives useful in the present invention are shown in the Table 2 below.

Note that many additives, additive concentrates, and additive packages that are purchased from manufacturers may incorporate a certain amount of base oil solvent, or diluent, in the formulation. Accordingly, the weight amounts in Table 3 below are directed to the amount of active ingredient (that is the non-solvent portion of the ingredient). The weight percents indicated below are based on the total weight of the lubricating oil composition. In practical applications, however, additive components, additive concentrates, and additive packages are used as purchased from manufactures, and may include certain amounts of base oil solvent or diluent. The additive and formulation components as recited in the Examples and Comparative Examples below are used “as is” from their manufacturers or suppliers, unless specifically noted otherwise.

TABLE 2
Typical Amounts of Various Lubricant Oil Components

| | Approximate | |
|---|---|---|
| | Weight Percent | Approximate Weight |
| Compound | (Useful) | Percent (Preferred) |
| Detergent | 0-6 | 0.01-4 |
| Dispersant | 0-20 | 0.1-8 |
| Friction Reducer | 0-5 | 0.01-1.5 |
| Viscosity Index Improver | 0-40 | 0.01-30, |
| | | more preferably |
| | | 0.01 to 15 |
| Antioxidant | 0.01-5 | 0.01-2 |
| Corrosion Inhibitor | 0.01-5 | 0.01-1.5 |
| Anti-wear Additive | 0.01-6 | 0.01-4 |
| Pour Point Depressant | 0-5 | 0.01-1.5 |
| Demulsifier | 0.001-3 | 0.001-1.5 |
| Anti-foam Agent | 0.001-3 | 0.001-0.15 |
| Base Oil(s) | Balance | Balance |

### EXAMPLES

### Example 1

By controlling other non-inventive process parameters well known to those skilled in the art, the base stocks and base oils as described by the inventive process herein can be made over a range of low to high viscosity oils as is typical in the industry thus allowing for blending of base stocks with a final viscosity between those two end points. In this example, the base stocks were manufactured using the inventive method to a higher viscosity level of 6.6 cSt and a lower viscosity level of 4.0 cSt. For this example, as may be seen in Table 3, the Inventive Oil A, derived from a mineral oil wax, was then blended to two viscometric targets: 4.0 cSt and 5.7 cSt. Similarly, the Inventive Oil B for this example was made from a Fischer-Tropsch wax, blended to final viscosity targets of 4.0 cSt and 6.3 cSt. The Comparitive Oils for this example are commercially available base stocks blended to viscometric targets of 4 cSt, 5 cSt and 8 cSt.

Viscometric properties of Base oils A and B and the Comparative Base Oil 1 at comparable viscosity indices are shown below (Table 3). The Kinematic Viscosities were measured by ASTM method D445. The measured CCS viscosity were found by using ASTM method D5293. The Theoretical Viscosity were calculated per the Walther/MacCoull Equation as found in ASTM D341 (Appendix 1). For this example, and as shown in FIG. 2, the linear Theoretical is Viscosity line for each oil of interest was determined from the kinematic viscosities taken at 40° C. and 100° C. The calculated Noack Volatilites were made by the equation: Noack(calc)=−6.882Ln(CCS@−35° C.)+67.647. Pour points (ASTM D97) of the base oils and comparative base oils in Table 3 are in the range of about −15° C. to −24° C., typically at least −18° C.

The ratio between measured and theoretical viscosity (i.e. ratio=measured/theoretical) at −30° C. or below is less than 1.2 for the Base Oils, but is higher than 1.2 for the Comparative Base Oils at the same temperatures. Measured Noack volatility for these base stocks and base oils is also shown, and compared to the CALCULATED Noack volatility limit of this invention recite herein (above). The base oils A and B clearly show measured Noack volatility below the calculated limit, whereas the comparative base oils Comp.Oil 1 and Comp.Oil 3 exceed the calculated Noack volatility limit.

TABLE 3
Base Stocks and Properties

| | | | | | Comparative Base Oil | | | |
|---|---|---|---|---|---|---|---|---|
| | Base Oil | | | | Comp. | Comp. | Comp. | Comp. |
| | Oil A | Oil A | Oil B | Oil B | Oil 1 | Oil 1 | Oil 1 | Oil 3 |
| | 4 cSt | 5.7 cSt | 4 cSt | 6.3 cSt | 4 cSt | 5 cSt | 8 cSt | 6.1 cSt |
| Viscosity | 142 | 150 | 143 | 153 | 142 | 146 | 146 | 130 |
| Index | | | | | | | | |

Kinematic Viscosity, ASTM D445

| | | | | | | | | |
|---|---|---|---|---|---|---|---|---|
| At 100 C., cSt | 4 | 5.7 | 3.8 | 6.30 | 4.0 | 5.1 | 8.0 | 6.1 |
| At 40 C., cSt | 16.8 | 28.4 | 15.3 | 31.8 | 16.5 | 24.1 | 46.3 | 33.8 |

CCS Viscosity (Measured), ASTM D5293

| | | | | | | | | |
|---|---|---|---|---|---|---|---|---|
| At −30 C., cP | TLTM | 2506 | 680 | 2630 | 1160 | 2270 | 8000 | 4290 |
| At −35 C., cP | 1354 | 4499 | 1140 | 4670 | 2440 | 4620 | THTM | 8380 |

Theoretical Viscosity (Walther/MacCoull Eq.)

| | | | | | | | | |
|---|---|---|---|---|---|---|---|---|
| At −30 C., cP | 894 | 2439 | 722 | 2806 | 866 | 1877 | 6056 | 4560 |
| At −35 C., cP | 1515 | 4364 | 1206 | 5019 | 1466 | 3329 | 11 340 | 8730 |

Viscosity Ratio, measured/theoretical

| | | | | | | | | |
|---|---|---|---|---|---|---|---|---|
| At −30 C., cP | — | 1.03 | 0.94 | 0.94 | 1.34 | 1.21 | 1.32 | 0.94 |
| At −35 C., cP | 0.89 | 1.03 | 0.94 | 0.93 | 1.66 | 1.39 | — | 0.96 |
| Noack | 15 | 9.7 | 16.4 | 4.5 | 14.8 | 10.5 | — | 6.9 |
| Volatility, | | | | | | | | |
| wt % | | | | | | | | |
| CALCULATED | 18 | 9.8 | 18.0 | 6.5 | 14.0 | 9.6 | 3.4 | 5.5 |
| Noack | | | | | | | | |
| Volatility | | | | | | | | |
| Limit, wt % | | | | | | | | |

(TLTM = too low to measure)
(THTM = too high to measure)

It has similarly being observed that the base stocks recited herein have a much lower scanning-Brookfield viscosity (ASTM D5133) values at low temperature (below −20° C.). Scanning Brookfield viscosity measurements are performed at much lower shear rates, and slower cooling rates than the D5293 CCS technique. In the particular example illustrate in table 4, the base stocks ratios of (measured/theoretically predicted) viscosity ranges between 2.5 (@−20° C.) and 7 (@−35° C.), while the comparable commercially available base stock, with similar viscosity and VI, has a ratio ranging between 11 (@−20° C.), and 63 (@−25° C.), and its viscosity is too high to be measured below −25° C.

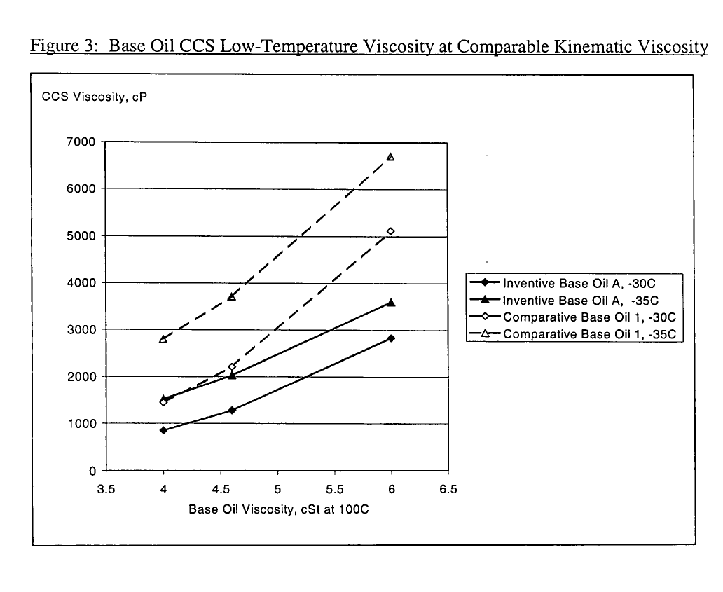

The viscosity-temperature performance for the Comparative Base Oil and the Base Oil are also demonstrably different over a range of base oil viscosity, as measured by kinematic viscosity at 100° C. At comparable kinematic viscosity at 100° C. and Noack volatility, it is evident that the Base Oil has superior (i.e. lower) low-temperature viscosity than that of comparative base oil 1, at temperatures such as, for example, −30° C. and −35° C. (Table 4 and FIG. 3).

TABLE 4
Base Oil CCS Low-Temperature Viscosity at Comparable
Kinematic Viscosity and Volatility

| | Base Oil A | | Comparative Base Oil 1 | |
|---|---|---|---|---|
| | 4-6.6 cSt Mixtures | | 4-8 cSt Mixtures | |
| | CCS @ - | CCS @ - | CCS @ - | CCS @ - |
| KV @ | 30° C. | 35° C. | 30° C. | 35° C. |
| 100 C., cSt | cP | cP | cP | cP |
| 4.0 | 857 | 1445 | 1524 | 2798 |
| 4.6 | 1282 | 2214 | 2032 | 3713 |
| 6.0 | 2830 | 5120 | 3600 | 6700 |

### Example 2

The wax derived base stocks that are used in the examples of formulated functional fluid compositions of this invention span a kinematic viscosity range from above 3 cSt to below 7 cSt at 100° C. Suitable combinations of these base stocks and base oils satisfy the base oil descriptions for the base oil compositions recited herein.

In order to assess achieving the desired high-temperature working performance expected, for example, of internal sintered metal lubricants, functional fluids were evaluated in a simple high-temperature laboratory bench test. Changes in lubricant evaporative loss are conveniently measured by measuring the increase in lubricant kinematic viscosity at 100° C. Increases in kinematic viscosity are sensitive to small levels of evaporative loss. The test procedure involves heating a candidate lubricant (initial test volume=25 ml) for a specified time and temperature in a glass test tube (23 mm inner diameter) with a steady stream of nitrogen (flow rate=10 L/hr) introduced through a narrow-diameter gas inlet tube (glass, 4 mm inner diameter, end cut at 45 degree angle; end positioned at bottom of test tube) into the lubricant and bubbled through the heated lubricant for the entire duration of the test. Kinematic viscosity at 100° C. of the candidate lubricant is measured before and after the test and the percent increase is calculated. The relative volatility of the candidate lubricant correlates positively with the percent increase in kinematic viscosity. The relative volatility of a series of candidate lubricants can then be ranked by ranking their respective percent increase in kinematic viscosity.

In this example, the inventive functional fluid composition is that of a circulating oil or a compressor oil. The performance additive package 1 is suitable for use in circulating or compressor oil compositions. However, this example does not limit the possible alternate functional fluid compositions that may be suitably used in this invention.

For the inventive functional fluid Inventive Sample 1, and for comparative examples CE.1, CE.2 and CE.3, all formulations are made with the same additive package, which is typically used in either circulating oils or compressor oils. The Inventive Sample was made using the novel base oil B employed in Example 1 above. The samples tested in this example are formulated to meet the same viscosity target of ISO 32, which is typical of many circulating and compressor oil products. The results are presented in Table 5.

TABLE 5
Inventive and Comparative Examples

| | Inven- | | | |
|---|---|---|---|---|
| | tive | | | |
| | Sample | Comparative Examples | | |
| | 1 | CE. 1 | CE. 2 | CE. 3 |
| Formulated Functional Fluid | | | | |
| Composition (wt %) | | | | |
| Base Oil B | 98.8 | | | |
| Group I Base Oil | | 98.8 | | |
| Group II Base Oil | | | 98.8 | |
| Comparative Base Oil 3 | | | | 98.8 |
| (Group III Base Oil) | | | | |
| Performance Additive Package 1 | 1.2 | 1.2 | 1.2 | 1.2 |
| (Antioxidants, inhibitors, anti- | | | | |
| corrosion, defoam, etc.) | | | | |
| Lubricant High-Temperature | | | | |
| Test: 325 F., 40 hrs | | | | |
| Wt % Kinematic Viscosity | 0.4% | 4.1% | 2.5% | 0.6% |
| (100 C.) Increase | | | | |
| Relative Volatility Loss | 1 | 4 | 3 | 2 |
| Ranking, Low-to-High | | | | |
| (Lowest Loss = 1) | | | | |

At high temperature and under gas purging conditions, functional fluid composition Inventive Sample 1 containing the base oil B demonstrates the lowest percent increase in viscosity and consequently the lowest lubricant evaporative loss (i.e. volatility loss) compared to any of the comparative examples, CE.1 through CE.3. More specifically, Inventive Sample 1 (formulated with base Oil B) outperforms comparative Example CE.3 (formulated with Group III base oil, Comparative Base Oil 3), by demonstrating a lower percent increase in viscosity and therefore a lower volatility loss. Example 1 demonstrates a surprising and advantageous 30% performance improvement compared to CE.3, which would therefore translate into Example 1 having a significantly longer service lifetime under high thermal stress than comparative example CE.3.

What is claimed is:

1. A functional fluid having improved viscosity and volatility control under conditions of high thermal stress comprising:
a) a base stock or base oil, said base stock or base oil having the properties of:
(a) a viscosity index (VI) of greater than 130;
(b) a pour point of about −10C or lower;
(c) a ratio of measured-to-theoretical low-temperature viscosity equal to about 1.2 or less, at a temperature of about −30C or lower, where the measured viscosity is cold-crank simulator viscosity and where theoretical viscosity is calculated at the same temperature using the Walther-MacCoull equation wherein said base stock or base oil is not a Group IV base stock or base oil; and
b) at least one additive.

2. A functional fluid having improved viscosity and volatility control under conditions of high thermal stress comprising:
a) a base stock or base oil, said base stock or base oil having the properties of:
(i) a viscosity index (VI) of about 130 or greater;
(ii) a pour point of about −10C or lower;
(iii) a ratio of measured-to-theoretical low-temperature viscosity equal to about 1.2 or less, at a temperature of about −30C or lower, where the measured viscosity is cold-crank simulator viscosity and where theoretical viscosity is calculated at the same temperature using the Walther-MacCoull equation;
(iv) a percent Noack volatility no greater than that calculated by the formula
−6.882Ln(CCS@−35C)+67.647,
where CCS@−35C is the base oil CCS viscosity in centipoise, tested at −35C, and that value as used in the equation is less than 5500 cP and wherein said base stock or base oil is not a Group IV base stock or base oil; and
b) at least one additive.

3. A lubricating having improved viscosity and volatility control under conditions of high thermal stress comprising:
a) at least one base stock or base oil wherein said base stock or base oil has a VI of at least 130 produced by a process which comprises:
(i) hydrotreating a feedstock having a wax content of at least about 60 wt. %, based on feedstock, with a hydrotreating catalyst under effective hydrotreating conditions such that less than 5 wt. % of the feedstock is converted to 650F (343C) minus products to produce a hydrotreated feedstock whose VI increase is less than 4 greater than the VI of the feedstock;
(ii) stripping the hydrotreated feedstock to separate gaseous from liquid product;
(iii) hydrodewaxing the liquid product with a dewaxing catalyst which is at least one of ZSM-48, ZSM-57, ZSM-23, ZSM-22, ZSM-35, ferrierite, ECR-42, ITQ-13, MCM-71, MCM-68, beta, fluorided alumina, silica-alumina or fluorided silica alumina under catalytically effective hydrodewaxing conditions wherein the dewaxing catalyst contains at least one Group 9 or Group 10 noble metal; and
b) at least one additive.

4. A functional fluid having improved viscosity and volatility control under conditions of high thermal stress comprising:
a) at least one base stock or base oil wherein said base stock has a VI of at least 130 produced by a process which comprises:
(i) hydrotreating a lubricating oil feedstock having a wax content of at least about 50 wt. %, based on feedstock, with a hydrotreating catalyst under effective hydrotreating conditions such that less than 5 wt. % of the feedstock is converted to 650F (343C) minus products to produce a hydrotreated feedstock to produce a hydrotreated feedstock whose VI increase is less than 4 greater than the VI of the feedstock;
(ii) stripping the hydrotreated feedstock to separate gaseous from liquid product;
(iii) hydrodewaxing the liquid product with a dewaxing catalyst which is at least one of ZSM-22, ZSM-23, ZSM-35, ferrierite, ZSM-48, ZSM-57, ECR-42, ITQ-13, MCM-68, MCM-71, beta, fluorided alumina, silica-alumina or fluorided silica-alumina under catalytically effective hydrodewaxing conditions wherein the dewaxing catalyst contains at least one Group 9 or 10 noble metal;
(iv) hydrofinishing the product from step (3) with a mesoporous hydrofinishing catalyst from the M41S family under hydrofinishing conditions; and
b) at least one additive.

5. A functional fluid having improved viscosity and volatility control under conditions of high thermal stress comprising:
a) at least one base stock wherein said base stock has a VI of at least 130 produced by a process which comprises:
(i) hydrotreating a lubricating oil feedstock having a wax content of at least about 60 wt. %, based on feedstock, with a hydrotreating catalyst under effective hydrotreating conditions such that less than 5 wt. % of the feedstock is converted to 650F (343C) minus products to produce a hydrotreated feedstock to produce a hydrotreated feedstock whose VI increase is less than 4 greater than the VI of the feedstock;
(ii) stripping the hydrotreated feedstock to separate gaseous from liquid product;
(iii) hydrodewaxing the liquid product with a dewaxing catalyst which is ZSM-48 under catalytically effective hydrodewaxing conditions wherein the dewaxing catalyst contains at least one Group 9 or 10 noble metal;
(iv) Optionally, hydrofinishing the product from step (3) with MCM-41 under hydrofinishing conditions; and
b) at least one additive

6. The functional fluid as in any one of claims 3, 4, or 5, wherein said feedstock is a synthetic gas to liquid feedstock.

7. The functional fluid as in any one of claims 3, 4, or 5, wherein said feedstock is made by a Fischer-Tropsch process.

8. A functional fluid of claims 1, 2, 3, 4 or 5 comprising at least one performance enhancing additive.

9. A functional fluid of claims 1, 2, 3, 4 or 5 comprising at least one performance enhancing additive where said performance enhancing additive is not a viscosity index improver.

10. A functional fluid of claims 1, 2, 3, 4 or 5 where said functional fluid is a circulating oil.

11. A functional fluid of claims 1, 2, 3, 4 or 5 where said functional fluid is a compressor oil.

12. A functional fluid of claims 1, 2, 3, 4 or 5 where said functional fluid is an internal lubricant for sintered metal materials.

13. The method of making a functional fluid having improved viscosity and volatility control under conditions of high thermal stress comprising incorporating a base stock or base oil having the properties of
(a) a viscosity index (VI) of 130 or greater,
(b) a pour point of −10C or lower,
(c) a ratio of measured-to-theoretical low-temperature viscosity equal to 1.2 or less, at a temperature of −30C or lower, where the measured viscosity is cold-crank simulator viscosity and where theoretical viscosity is calculated at the same temperature using the Walther-MacCoull equation.
wherein said base stock or base oil is not a Group IV base stock or base oil.

14. The method of making a functional fluid having improved viscosity and volatility control under conditions of high thermal stress comprising incorporating a base stock or base oil having the properties of
(a) a viscosity index (VI) of 130 or greater,
(b) a pour point of −10C or lower,
(c) a ratio of measured-to-theoretical low-temperature viscosity equal to 1.2 or less, at a temperature of −30C or lower, where the measured viscosity is cold-crank simulator viscosity and where theoretical viscosity is calculated at the same temperature using the Walther-MacCoull equation, and
(d) a percent Noack volatility no greater than that calculated by the formula
−6.882Ln(CCS@−35C)+67.647,
where CCS @−35C is the base oil CCS viscosity in centipoise, tested at 35C, and that value as used in the equation is less than 5500 cP, and wherein said base stock or base oil is not a Group IV base stock or base oil.

15. A method of reducing the Noack volatility of a functional fluid comprising incorporating said base stock or base oil of any one of the claims 1, 2, 3, 4 or 5.
